(19) United States
(12) Patent Application Publication
(10) Pub. No.: US 2010/0225963 A1
(43) Pub. Date: Sep. 9, 2010

(54) MANAGEMENT APPARATUS, MANAGEMENT METHOD, AND PROGRAM

(75) Inventor: Masashi Kuroshima, Tokyo (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/701,481

(22) Filed: Feb. 5, 2010

(30) Foreign Application Priority Data
Mar. 3, 2009 (JP) 2009-049714

(51) Int. Cl. G06F 15/00

(52) U.S. Cl. 358/1.15

(57) ABSTRACT

Upon execution of re-print processing of a variable job, a re-print range is set in consideration of finishing setting information to facilitate a replace operation. Or the range is presented. Also, a re-print range that allows an easy replace operation by the user is set to have the smaller number of pages to be re-printed as much as possible in consideration of subset execution ranges depending on the capability of a printer.

### BACKGROUND OF THE INVENTION

1. Field of the Invention

The present invention relates to a management apparatus, management method, and program in a print system.

2. Description of the Related Art

In a so-called in-house print business, a generation request of printed products (manuals, reports for customers, etc.) ordered from a client as a certain department in a company is received, and desired printed products are generated and are delivered to the client. Conventionally, as a print system which executes print processing for a file received from a customer, a print processing system which uses a so-called hot folder function is known. An example of the arrangement of a POD system using a conventional hot folder function will be described below with reference to FIGS. 1 to 4. An example of variable print processing in the POD system using the conventional hot folder function will be described below with reference to FIGS. 5 and 10. Also, an example of a variable job will be described below with reference to FIGS. 6 and 7. In this embodiment, a description will be given using ISO 16612-2 (tentative name: vPDF) discussed in ISO TC130 WG/TF3. An example of a job ticket which records print instruction information will be described below with reference to FIGS. 8 and 9. In this related art, a description will be given using, as a job ticket, JDF (Job Definition Format) data defined by CIP4. An example of variable print processing carried out in accordance with a conventional subset staple instruction will be described below with reference to FIG. 10.

FIG. 1 is a block diagram showing an example of a POD system, and an example of the basic arrangement of a whole print system according to the present invention. In this block diagram, the print system includes one or a plurality of operator environments 1 and 2, and a POD (Print On Demand) site environment 3 connected via the Internet.

In the operator environments 1 and 2, data to be printed by the POD site is generated. Each operator environment includes an operator who issues a print order request. The respective operator environments (operator environments A and B in this case) can issue print job requests and can confirm job statuses using respective client PCs.

On the other hand, the POD site environment 3 normally includes a hot folder section 4 and digital print section 5. However, the POD site environment 3 may often also include a post-press section (not shown) when the function and capability of a finishing device connected to each digital image forming apparatus such as a digital copying machine or digital multifunction peripheral (MFP) do not suffice.

The hot folder section 4 fulfills a role to append, to an entered file, a print instruction (to be referred to as a job ticket hereinafter) associated with that hot folder section 4, and to transfer that file to the digital print section 5. Also, the hot folder section 4 also functions as a process management unit. That is, the hot folder section 4 instructs operations to respective processes of the hot folder section 4 and digital print section 5 (including the post-press section if necessary) in the POD site environment, and uniformly manages the workflows of this system including computers and various devices. Then, the hot folder section 4 serves to receive and store print jobs from the aforementioned operators, and to schedule operations of the respective devices and operators to attain high efficiency.

The digital print section 5 executes print processing according to an operation instruction of a print job received from the hot folder section 4. As another POD processing, the digital print section 5 copies paper documents using a print device having a print function such as a monochrome MFP or color MFP. Also, the digital print section 5 serves to print out a document/image file received from an operator of a client PC via a printer driver, a scan image file scanned by a scan device, and also a document/image file obtained by editing such file, to a print device such as a monochrome MFP or color MFP.

When the post-press section is also included, it controls post-processing devices such as a paper folding device, saddle stitching device, case binding device, cutting device, enclosing device, and collecting device in accordance with an operation instruction of a post-press job received from the hot folder section 4 or digital print section 5. In addition, the post-press section serves to execute finishing processes such as paper folding, saddle stitching, case binding, cutting, enclosing, and collecting with respect to printed sheets output from the digital print section 5.

FIG. 2 is a block diagram showing the arrangement of the hot folder section 4 in the above print system and an example of the operator environments allocated on an external network. The hot folder section 4 includes a hot folder server 20, file server 21, and hot folder clients 22 and 23, which are connected to a network. The hot folder server 20 manages the workflow of the overall system from reception of order until delivery of goods, and controls the hot folder clients 22 and 23.

The file server 21 receives files to be printed from the operator environments using the Internet. Also, the file server 21 is a document management server which stores files received from an operator in preparation for a re-outsourcing request using identical documents from the operator. In general, the file server 21 saves image data and print jobs used at the time of previous output processing together.

Each of the hot folder clients 22 and 23 is installed with a hot folder client application which sends a file received from an operator to the hot folder server 20, so as to convert that file into a format that can be processed in the POD system 3 and to output the converted file to the digital print section 5. For example, upon reception of variable data or a contents file from an operator, the hot folder client 22 or 23 converts the variable data or contents file into a print job by appending a JDF file, and sends the print job to the digital print section 5. The print setting information used among the hot folder server 20, file server 21, and hot folder clients 22 and 23 in the hot folder section 4 is called a JDF file. This JDF file is exchanged using, for example, a job ticket having an operation instruction of a job. Then, the JDF file allows to automate the total workflow in cooperation with the digital print section 5 (and also the post-press section) with a focus on the hot folder section 4 by transferring print jobs and issuing control commands.

FIG. 3 is a block diagram showing an example of the arrangement of the digital print section 5 in the print system. The digital print section 5 includes a print server 30, client PCs 31 and 32, color MFPs 35, 36, and 37, and monochrome MFPs 33 and 34, which are connected to a network.

The print server 30 has two roles. The first role is to exchange information with devices outside the digital print section 5. That is, with this role, the print server 30 receives image information, setting information, and the like of a job to be processed, and serves to notify an external device of information such as a status upon completion of that job. The second role is to execute management control inside the digital print section 5. That is, the print server 30 uniformly manages externally input jobs and jobs generated inside the digital print section 5. The print server 30 can monitor the statuses of all devices and all jobs in the digital print section 5. At the same time, the print server 30 can execute various kinds of control such as suspension control, setting change control, and printing resume control of jobs, or duplicate control, movement control, and deletion control of jobs.

Each of the client PCs 31 and 32 serves as an assistant which monitors and controls devices and jobs managed in the print server 30. As another POD service, each of the client PCs 31 and 32 serves to edit an input application file, to issue a print instruction, or to enter a print ready file. The color MFPs 35, 36, and 37, and the monochrome MFPs 33 and 34 are image forming apparatuses having various functions such as a scan function, print function, and copy function, and are selectively used as their usages since the color MFPs and monochrome MFPs have different speeds and costs. A finisher device is connected to the color MFP 37.

FIG. 4 is a block diagram showing an example of the overall arrangement of this related art. In FIG. 4, the overall arrangement includes hot folder clients 22, 23, and 40. Reference numerals 46 to 48 denote hot folder client applications, which are independently described as the hot folder clients 22, 23, and 40, but they may be configured on a single PC.

A hot folder server application 4a includes a sending queue used to transfer print data to a print device such as the color MFP 37. Data set in the sending queue are sent to the color MFPs 36 and 37 in the order they are set. A job management application 49 is used to monitor a print job sent from the hot folder server application 4a and to monitor statuses of print jobs accumulated in the color MFP 37.

A job controller 4b installed in the color MFP 37 includes a print queue. The color MFP 37 executes print processing in the order print jobs are set in the print queue. In the print queue, a print job that has undergone RIP (Raster Image Processor) processing is set, and is subject to various limitations of the color MFP 37. A job processor 4c implements print execution processing of jobs recorded in the print queue. A job controller 4d and job processor 4e are respectively the same as the job controller 4b and job processor 4c. In the related art, a print job that has undergone the RIP processing is set in the print queue. However, in embodiments of the present invention to be described later, a print job before the RIP processing may be set in the print queue.

Variable print processing using a conventional hot folder will be described below with reference to FIG. 5. Reference numeral 50 denotes a VDP (Variable Data Printing) application used to generate variable data. Reference numeral 51 denotes a variable data file generated by the VDP application; and 52, a hot folder which indicates hot folders 46, 47, and 48 in FIG. 4. Reference numeral 53 denotes a job ticket including a JDF file generated by the hot folder server application 4a. The color MFP 37 executes print processing of a variable job.

FIGS. 6 and 7 are views showing an example of the structure of variable data. FIG. 6 is a view as an example for explaining the variable data structure from output results. FIG. 6 shows an example of variable data of construction status reports that report construction statuses of construction by construction companies. That is, variable data in FIG. 6 include print data for customers A to L as construction companies. Each construction company possesses a plurality of construction properties, which form a report to one construction company. Reference numeral 51 denotes variable data; and 60, a data group which forms a report for customer A. In this embodiment, whole outputs for customer A are set as a staple range. Reference numeral 61 denotes a data group which forms a report for customer L. Reference numeral 62 denotes a data group which forms a status report of property 1 during construction by the construction company as customer A. In this embodiment, each data group is formed by records as units. The format of a report is decided for each property, and includes photo data used to explain a status of the job site as variable data. Reference numeral 63 denotes a data group which forms a status report of property 2 as in the data group 62. Reference numerals 64 and 65 denote data groups which respectively form status reports of properties M−1 and M. Reference numerals 66 and 67 denote illustrations which clearly specify output products respectively obtained based on the reports 60 and 61 via saddle stitching and stapling.

FIG. 7 is a view as an example for explaining the variable data structure from the variable data format. In FIG. 7, a description will be given with reference to a vPDF™ format. Variable data is formed by a hierarchical structure of a JOB node, Document SET nodes, and the like. Reference numeral 70 denotes a JOB node as a root node of the variable data; and 71, a Document SET node as one data group in the variable data. Reference numeral 72 denotes a Page tree node which bundles Page nodes, and corresponds to the data group 62 (i.e., record) in FIG. 6. Reference numeral 73 denotes a Page node which corresponds to each page in the record as the data group 62 in FIG. 6. Reference numeral 74 denotes variable data, which corresponds to that located in each record in FIG. 6. In FIG. 7, each Page node 73 is coupled to each XObject node 74. This means that each page data refers to corresponding variable data. Variable data can be referred to from a plurality of pages. Reference numeral 75 denotes reference information which is recorded in each variable data 74 and is used to refer to an external DB. Each reference information 75 records a DB name and reference information indicating a data position in the DB.

FIG. 8 is a view showing an example of the structure of a JDF file included in a job ticket. Reference numeral 80 denotes whole JDF data. A field 82 describes a plurality of Prepress processing instructions indicating, for example, what kind of image processing is applied to contents data such as PDF data, and how to lay out the contents data. A field 83 describes a plurality of Press processing instructions indicating, for example, how to output image data generated by the Prepress processing 82 onto documents. A field 84 describes Postpress processing instructions indicating what kind of post-processing (e.g., case binding and the like) is to be applied to the documents output according to the instructions of the Press processing 83. A field 81 describes Combined Process processing which combines the Prepress, Press, and Postpress processes 82, 83, and 84. Normally, in the color MFP 37, which executes digital print processing, a bookbinding result obtained after execution of the Prepress, Press, and Postpress processes with respect to an input of a single print job is only one output. When the user wants to instruct to process a series of processes including the Prepress, Press, and Postpress processes simultaneously for a single input and to obtain only one output in this way, the Combined Process processing is used. The Combined Process processing is always used as an instruction to a digital image forming apparatus such as an MFP which has at least two of the Prepress, Press, and Postpress processes.

FIG. 9 is another view showing an example of the structure of a job ticket used in, for example, the POD system. JDF data which expresses a job ticket is described in an XML format, and can be expressed by a hierarchical structure of nodes. FIG. 9 is a hierarchy chart showing an example of bookbinding based on JDF data. On the other hand, FIG. 8 shows the JDF structure as the types of processes to be executed.

A book 91 as a whole is finished via various processes including generation of a cover 92, that of book contents 93, and bookbinding of them. In JDF data, processes required to form physical output products upon configuring output products are called product nodes. Processes required to form product nodes are called process nodes, and groups of some process nodes as elements in an intermediate stage for generating product nodes are called process group nodes distinctly.

More specifically, the Prepress processing 82 in FIG. 8 corresponds to RIP processing 9a of color pages and RIP processing 9c of monochrome pages. The Press processing 83 corresponds to a cover output process 1 98, cover laminate processing 99, color page print processing 9b, and monochrome page print processing 9d. The Postpress processing corresponds to case binding processing 9e and cutting processing 9f.

FIG. 10 explains an example of variable print processing including a conventional subset staple instruction. Reference numeral 10 denotes printed products which are saddle-stitched and stapled, and which correspond to, for example, the printed products 66 in FIG. 6. The same applies to printed products 11 and 12. Then, a setting for punching two or three punch holes in a whole saddle-stitched book including the printed products 10 to 12 is made, thus punching punch holes. Using these punch holes, the output products are bound by, for example, a binder. Such output is used in, for example, a case in which pages for each chapter are stapled, and all stapled page sets are bound by a binder as a reference to be delivered in, for example, a workshop. FIG. 10 exemplifies saddle stitching. However, only the upper left side of pages may be stapled. Also, as is known, a finishing device executes bookbinding processes (stapling, punching, saddle stitching, case binding, etc.) of document sheets output from a conventional image forming apparatus.

As a related art, the following technique is available (for example, see Japanese Patent Laid-Open No. 2003-167719). In this technique, upon execution of re-print processing at the time of a printer failure, a staple attribute set in a print job whose print processing is interrupted is checked, and a job which includes the start page of the re-print processing as a first page of stapling is sent.

The aforementioned related art does not include any disclosure about a display mode for the re-print processing with high usability on a job history list provided by a job management apparatus. Especially, the related art does not assume to display “variable jobs and records” and “a finishing range”.

The related art does not include any description about processing for limiting a print range to a finishing range at the time of designation of the print range upon execution of, for example, re-print processing or indication of the finishing range.

Also, the related art does not include any description about processing for changing to reduce a selection range to a finishing (staple) range when “record range>finishing range” upon designation of a print range.

Furthermore, when a print range is that for a variable job, a finishing range cannot be determined by checking a JDF file as an independent file.

As described above, no high-usability function required to obtain desired output products at the time of re-print processing executed when, for example, the user replaces data is provided.

### SUMMARY OF THE INVENTION

The present invention has been made in consideration of the aforementioned related arts. Upon execution of re-print processing of a variable job to which a subset finishing setting such as stapling is applied, print processing which decides a print range in consideration of the finishing setting, and allows the user to execute easy replace processing after printing is carried out.

The print range is characterized by considering enlargement/reduction depending on the finishing setting range, updating of variable data, or the like.

The present invention provides a display method that allows the user to easily recognize a print range that facilitates the replace processing upon displaying a print history of the variable job.

The thickness of paper sheets to be stapled by a device has an upper limit. When subset stapling and case binding are executed within ranges smaller than those intended by the user depending on the capability of the finishing function of the device without the user's intent, a print range which facilitates a replace operation is presented to the user.

According to one aspect of the present invention, there is provided a management apparatus for managing a job to be processed by a peripheral device having a finishing function, comprising: a selection unit which accepts a user's selection of a record to be printed upon processing the job including a plurality of records; a determination unit which determines a finishing setting set in the job; a decision unit which decides, as print targets, a plurality of records, which include the record to be printed selected by the user's selection accepted by the selection unit and which have the finishing setting determined by the determination unit; and a generation unit which generates print instruction information based on the plurality of records to be printed, which are decided by the decision unit.

According to the present invention, since printed products are output for each subset finishing unit as a replace unit of the printed products, output products of replace positions desired by the user can be easily obtained.

Also, re-print processing can be executed within a shorter period of time than job re-generation processing by a job generation application since it uses a previously generated job.

Furthermore, even when subset finishing output are executed by a device, output products of replace positions desired by the user can be easily obtained within a minimum range.

Further features of the present invention will become apparent from the following description of exemplary embodiments (with reference to the attached drawings).

### BRIEF DESCRIPTION OF THE DRAWINGS

FIG. 1 is a block diagram showing an example of the arrangement of a conventional print system;

FIG. 2 is a block diagram showing an example of the arrangement in a conventional hot folder section;

FIG. 3 is a block diagram showing an example of the arrangement in a conventional digital print section;

FIG. 4 is a block diagram showing an example of the overall arrangement in the conventional hot folder section and that according to an embodiment of the present invention;

FIG. 5 is a view for explaining variable print processing using the conventional hot folder;

FIG. 6 is a first view for explaining conventional variable data;

FIG. 7 is a second view for explaining conventional variable data;

FIG. 8 is a first view for explaining the configuration of conventional JDF data;

FIG. 9 is a second view for explaining the configuration of conventional JDF data;

FIG. 10 is a view for explaining a variable job including a conventional subset staple setting;

FIG. 11 is a block diagram of a hot folder client PC and hot folder server according to the first embodiment;

FIG. 12 is a detailed block diagram of a hot folder application, hot folder server application, and job management application according to the first embodiment;

FIG. 13 is a block diagram of a color MFP according to the first embodiment;

FIG. 14 is a block diagram of an MFP control unit according to the first embodiment;

FIG. 15 is a view for explaining a variable job according to the first embodiment;

FIG. 16 is a view for explaining a job management application dialog according to the first embodiment;

FIG. 17 is a second view for explaining the job management application dialog according to the first embodiment;

FIG. 18 is a flowchart for explaining the first embodiment;

FIG. 19 is a second flowchart for explaining the first embodiment;

FIG. 20 is a view for explaining an example of a variable job according to the second embodiment;

FIG. 21 is a view for explaining an example of a job management application dialog according to the second embodiment;

FIG. 22 is a flowchart for explaining the second embodiment;

FIGS. 23A and 23B are views for explaining an example of a job management application dialog according to the third embodiment;

FIG. 24 is a flowchart for explaining the third embodiment;

FIGS. 25A and 25B are views for explaining an example of a job management application dialog according to the fourth embodiment;

FIG. 26 is a flowchart for explaining the fourth embodiment;

FIGS. 27A and 27B are views for explaining an example of a job management application dialog according to the fifth embodiment;

FIG. 28 is a flowchart for explaining the fifth embodiment;

FIG. 29 is a view for explaining an example of a job management application dialog according to the sixth embodiment;

FIG. 30 is a view for explaining a division example of subset staple ranges in a device according to the sixth embodiment; and

FIG. 31 is a flowchart for explaining the sixth embodiment.

### DESCRIPTION OF THE EMBODIMENTS

### First Embodiment

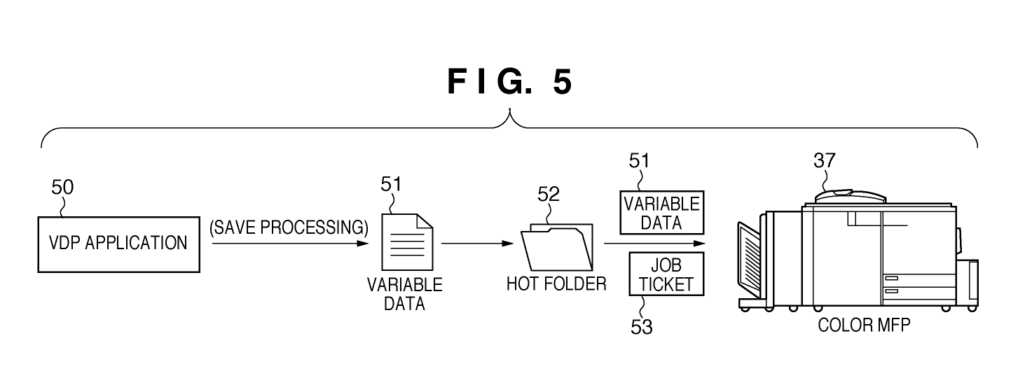

Embodiments according to the present invention will be described hereinafter with reference to the accompanying drawings. As described above in the related art shown in FIG. 5, the present invention uses re-print processing in a variable job whose print processing has been executed using a hot folder. As a format which describes setting information associated with variable data, PPML™ is generally known. The PPML can define print instruction data as a file independent from print data. This typical example is the case in which a print instruction setting is made using a hot folder shown in FIG. 5.

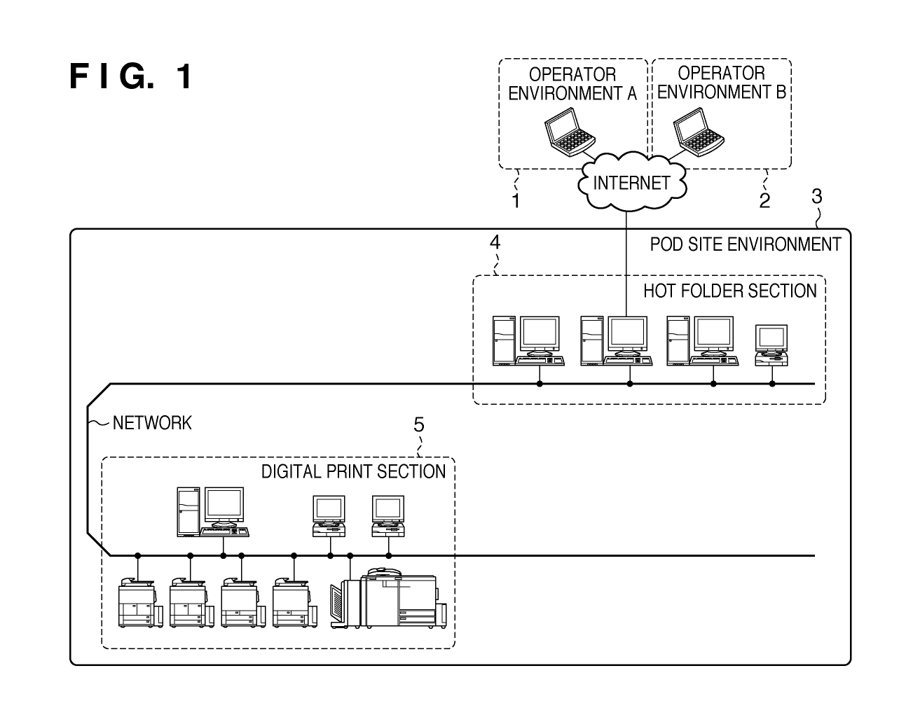

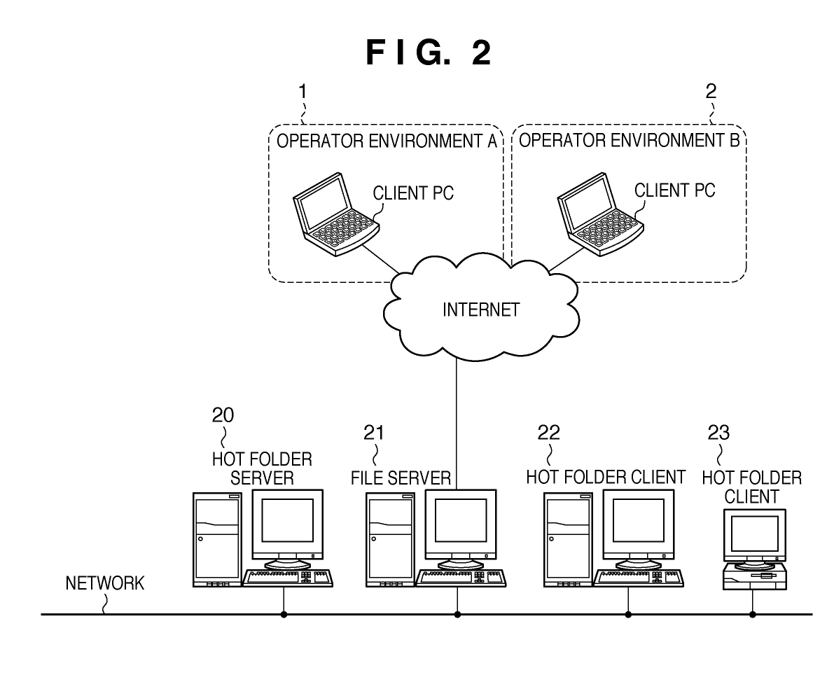

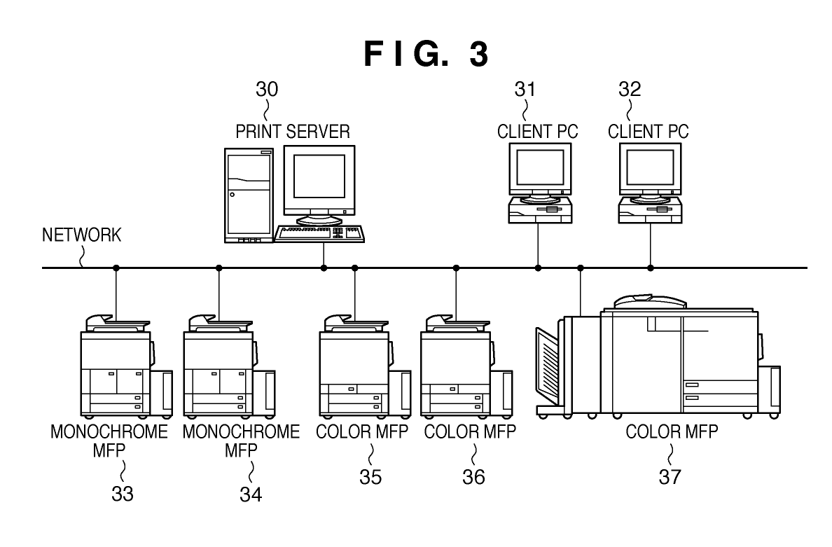

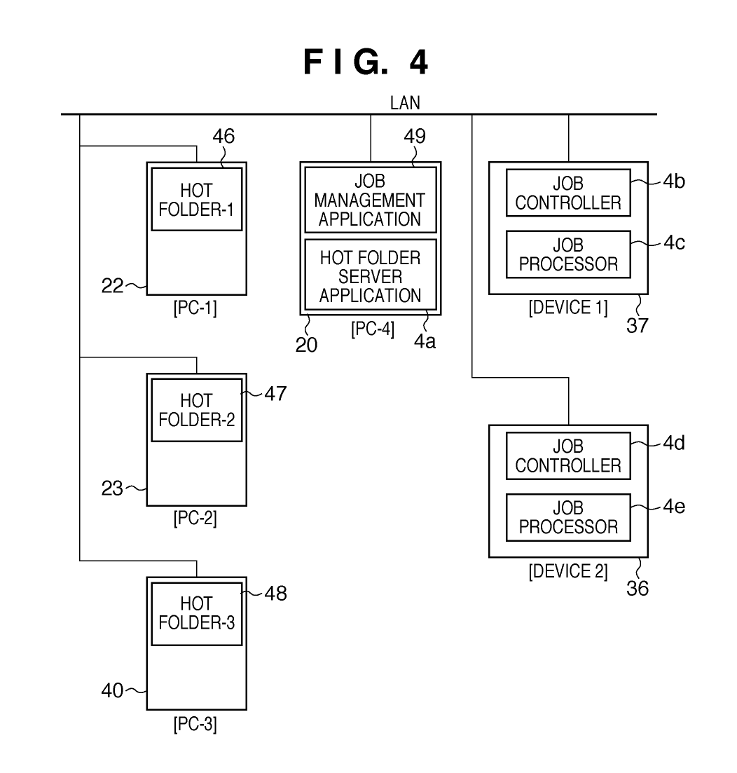

As has been described in the related art example shown in FIGS. 1 to 4, the present invention is carried out using the same print system basic arrangement. FIG. 5 describes a VDP application 50, but any other upstream-side applications may be used as long as they generate a variable data file. Variable data 51 generated by the VDP application 50 in FIG. 5 is input to a hot folder 52 in FIG. 5. This hot folder corresponds to a hot folder-1 46, hot folder-2 47, and hot folder-3 48 in FIG. 4. After the variable data is processed by a hot folder server application 4a, it is sent to a device 1 37 to execute the first print processing. A history of that variable job is recorded by a job management application 49. A re-print operation in this job management application 49 will be described below.

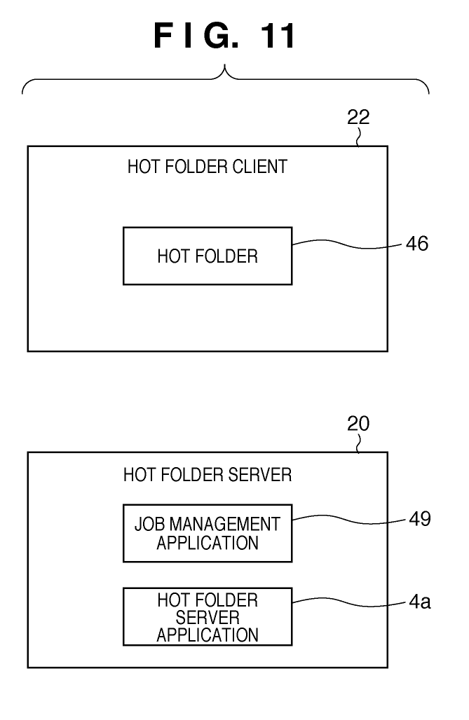

FIG. 11 is a block diagram for explaining a hot folder client 22 and a hot folder server 20 as a job management system in FIG. 4. Reference numeral 46 denotes a hot folder client application used to enter a file which is to undergo print processing. A hot folder server application 4a manages a plurality of hot folder client applications. A job management application 49 monitors and displays a status of a print job sent from the hot folder server application 4a.

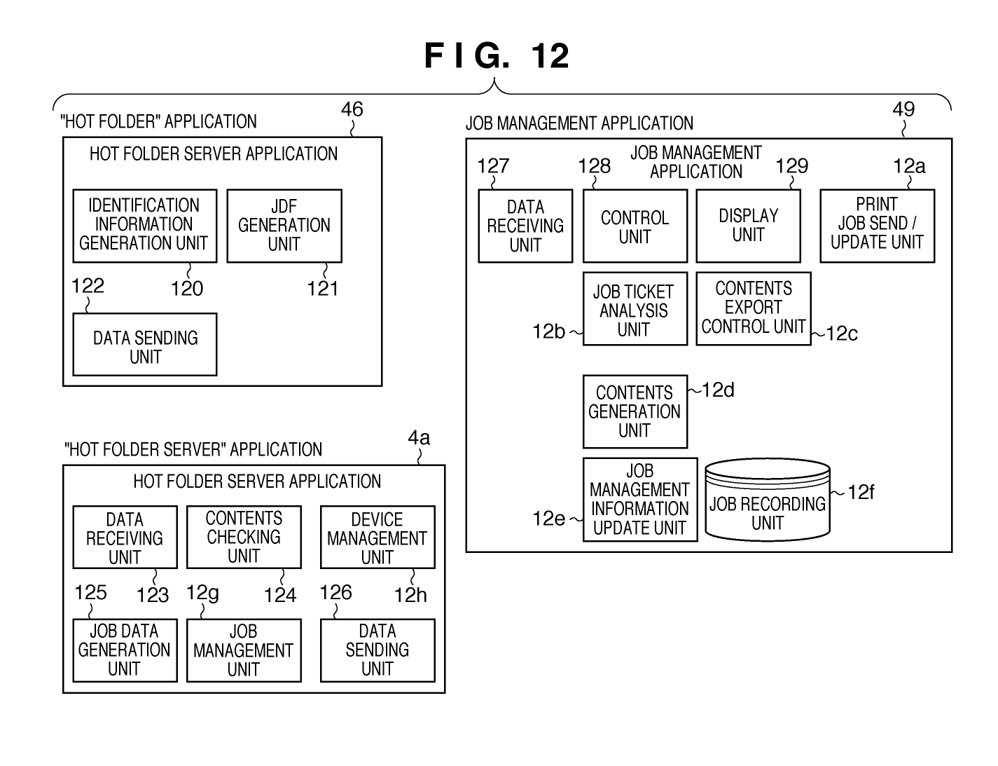

FIG. 12 is a block diagram for explaining the hot folder client application 46, hot folder server application 4a, and job management application 49. An identification information generation unit 120 operates when a print job is generated for a file to be processed, which is entered to a hot folder. This identification information generation unit 120 generates identification information including a hot folder name which allows to identify the print job, a serial number sequentially assigned to an entered file, and a file entry date. A JDF generation unit 121 generates a JDF file as a print instruction information file based on print instruction information set in association with the hot folder application 46. A data sending unit 122 sends the entered file and the JDF file generated by the JDF generation unit 121 to the hot folder server application 4a.

A data receiving unit 123 receives the files sent from the data sending unit 122 of the hot folder client application 46. The hot folder server application 4a controls a contents checking unit 124 to check if the received contents file to be printed is supported. As the checking method, the contents checking unit 124 checks if the received file has a file type to be printed, and also checks, for example, the file format version of the received file. A job data generation unit 125 executes MIME encoding using the received JDF file and contents file and generates a print job compliant with the JDF specification. A data sending unit 126 sends the print job generated by the job data generation unit 125 to the job management application 49. When a print job sent from a hot folder is to be managed, but its status need not be displayed on a display unit such as a CRT, the hot folder server application 4a may directly send the print job to a printer such as an MFP. A device to be used in print processing is set in advance for each hot folder application. A device management unit 12h manages the configuration information, functions, and the like of a color MFP 37 and monochrome MFP 33. The device management unit 12h also manages information of paper sheets set in cassettes of the color MFP 37, the capability of a staple function connected as a finishing device, and the like. A job management unit 12g manages a print job which is being processed by the hot folder server application 4a. After a job is transferred from the data sending unit 126 to the job management application 49, the job is managed on the job management application 49.

A data receiving unit 127 receives the print job sent from the data sending unit 126 of the hot folder server application 4a. A control unit 128 controls the processing of the job management application as a whole, and also controls a job operation to, for example, stop a job whose print processing is in execution, and a screen operation of, for example, re-print processing of a job. A job ticket analysis unit 12b analyzes a JDF file of a job ticket included in the received print job. A contents export control unit 12c controls processing for exporting contents data from a job held by the job management application 49. A contents generation unit 12d generates a contents file upon exporting contents from the job. The contents generation unit 12d generates a file under a folder in a path designated by the user using an input device (e.g., a keyboard), and sorts pages of the contents according to an instruction from the contents export control unit 12c. A job management information update unit 12e updates information recorded in a job recording unit 12f based on a result received by the data receiving unit 127. A display unit 129 displays job information managed by the job management information update unit 12e as a list on a screen, thereby displaying statuses of jobs and a history of sent jobs. A print job send/update unit 12a sends a job from the job management application 49 to a device such as the MFP 37. Also, the print job send/update unit 12a receives status information of the job from the MFP 37, records the status information of the job in the job recording unit 12f, and displays the updated status information on the screen using the display unit 129.

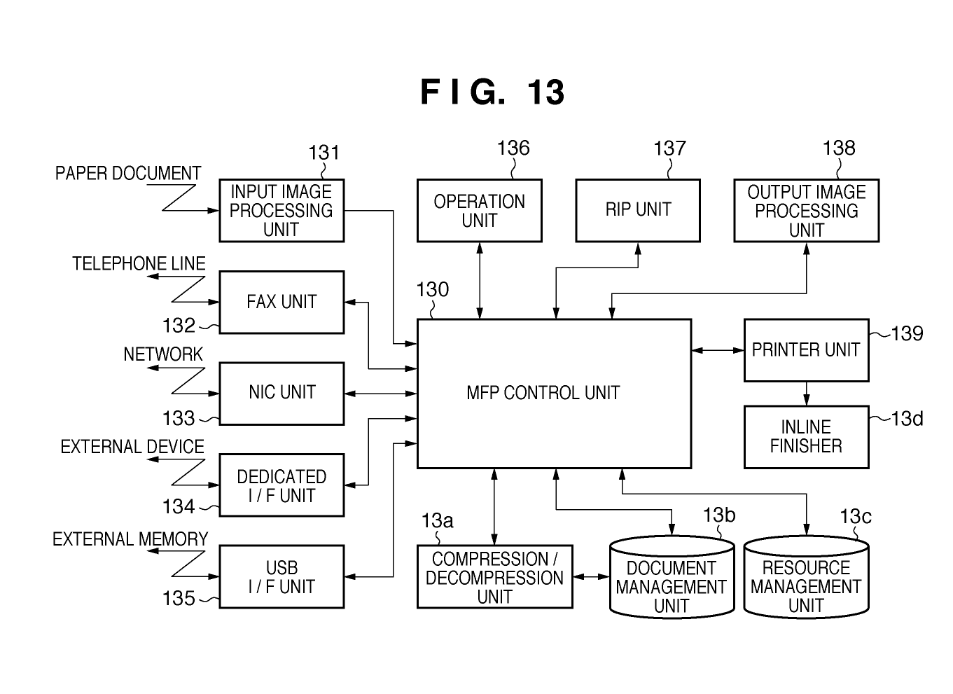

FIG. 13 is a block diagram for explaining the color MFP 37 in detail. An MFP is a multifunctional peripheral device installed with a plurality of functions including at least an image forming function, and includes a memory such as a hard disk that can store a plurality of job data. For example, typical functions of the MFP include a copy function which allows job data output from a scanner to be printed by a printer unit, and a print function which allows job data output from an external device such as a computer to be printed by the print unit via the memory.

As the MFP, a full-color device and monochrome device are generally available. Reference numeral 37 denotes a color MFP. The arrangement of this print system includes an MFP including a plurality of functions. However, this print system may use an image forming apparatus which does not include any scanner function and includes only a print function and finishing function. For example, this print system may have an arrangement in which a printer and a post-processing apparatus are connected to an identical network. Also, this print system may have an arrangement including a plurality of MFPs. In any case, this print system may have an arrangement having a printing apparatus which can implement the control of this embodiment.

The arrangement shown in FIG. 13 will be described below. An input image processing unit 131 reads an image on, for example, a paper document, and applies image processing to the read image data. A FAX unit 132 exchanges image data with an external device using a telephone line represented by a facsimile line. A NIC (Network Interface Card) unit 133 exchanges image data and device information using a network. A dedicated I/F (interface) unit 134 exchanges information such as image data with an external device. A USB I/F unit 135 exchanges image data and the like with a USB (Universal Serial Bus) device represented by a USB memory (a kind of removable medium). An MFP control unit 130 controls the overall MFP to temporarily store image data and to decide a route according to the use purpose of the MFP.

A document management unit 13b has a storage area of a hard disk or memory, which can store a plurality of image data, and is mainly controlled by a control unit (e.g., a CPU of the MFP control unit 130). For example, the document management unit 13b stores, in the storage area, a plurality of types of image data including that from the input image processing unit 131, that of a FAX job input via the FAX unit 132, that input from an external device such as a computer via the NIC unit 133, and various image data input via the dedicated I/F unit and USB I/F unit 135. The document management unit 13b reads out image data stored in the storage area as needed, transfers the readout image data to an output unit such as a printer unit 139, and executes output processing such as print processing using the output unit. Also, the document management unit 13b transfers image data read out from the storage area to an external device such as a computer or another image forming apparatus in accordance with an instruction from an operator.

Processing for compressing image data upon storing image data in the document management unit 13b and processing for decompressing stored compressed image data to original image data upon reading out the compressed image data are required as needed. A compression/decompression unit 13a applies such processes to image data. It is generally known that data transferred via a network is exchanged in a compression data format such as JPEG, JBIG, or ZIP. After compressed data is input to the MFP, it is unpacked (decompressed) by this compression/decompression unit 13a. A resource management unit 13c stores, for example, various parameter tables to be commonly handled such as fonts, color profiles, and gamma tables. The resource management unit 13c can be referred to as needed, and new parameter tables can be added and updated to the resource management unit 13c.

Upon reception of PDL (Page Description Language) data, the MFP control unit 130 controls a RIP (Raster Image Processor) unit 137 to apply RIP processing to that PDL data. The MFP control unit 130 controls an output image processing unit 138 to apply image processing required for print processing to an image to be printed as needed. Furthermore, the MFP control unit 130 can also store intermediate data of image data and print ready data (bitmap data to be printed or data obtained by compressing that bitmap data) generated in the image processing in the document management unit 13b again as needed. After that, data to be printed is sent to the printer unit 139. Printed document sheets printed out by the printer unit 139 are fed into an inline finisher 13d as a post-processing unit, and undergo sort processing and finishing processing of the sheets.

The MFP control unit 130 serves to smoothly control a job, and switches paths according to modes of using the MFP. Examples of such modes are listed below. The list is described by omitting the processes of the compression/decompression unit 13a used as needed, the post-processing unit (the inline finisher 13d, etc.), and the MFP control unit 130 as the core of the whole apparatus, so that approximate flows can be recognized.

FAX receiving function: FAX unit 132→output image processing unit 138→printer unit 139

Network print: NIC unit 133→RIP unit 137→output image processing unit 138→printer unit 139

Print from external device: dedicated I/F unit 134→output image processing unit 138→printer unit 139

Print from external memory: USB I/F unit 135→RIP unit 137→output image processing unit 138→printer unit 139

Box print function: document management unit 13b→printer unit 139

Note that the box print function is a processing function of the MFP using the document management unit 13b, and is a function of temporarily saving data by dividing the memory in the document management unit 13b for respective jobs and respective users, and inputting/outputting data by combining a user ID and password.

Furthermore, an operation unit 136 is used to allow an operator to select various flows and functions described above, and to input operation instructions. Note that since a display device of the operation unit 136 gains a higher resolution, image data stored in the document management unit 13b may be previewed, and may be printed if it is OK after confirmation.

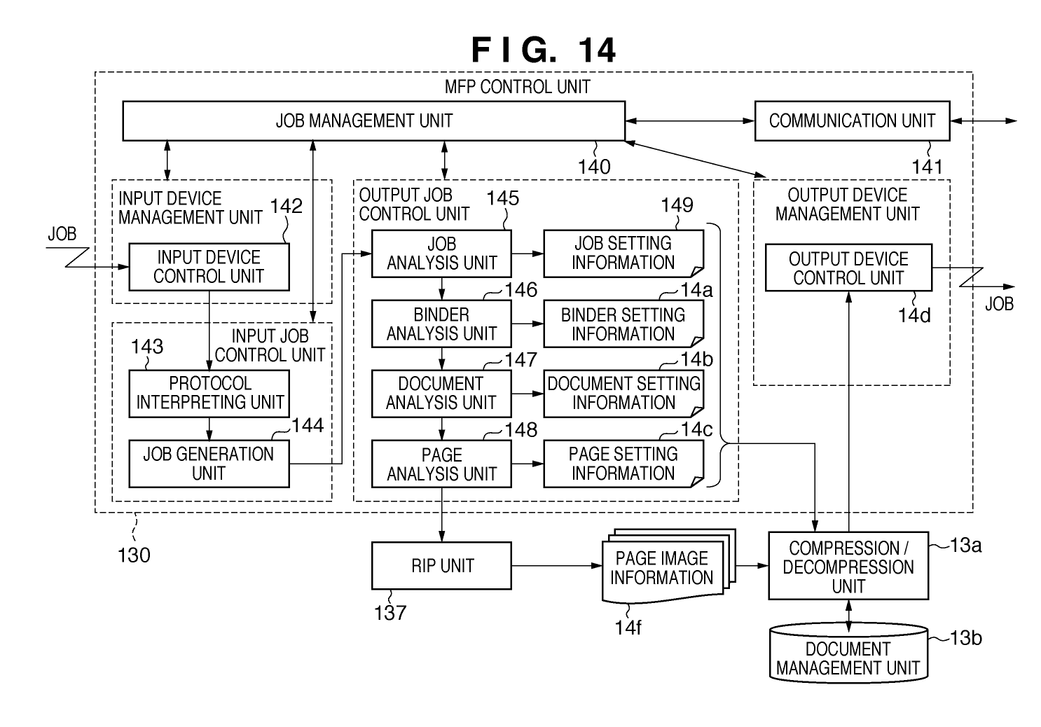

FIG. 14 is a block diagram for explaining the MFP control unit 130 in detail. FIG. 14 roughly includes five blocks. More specifically, FIG. 14 includes an input device management unit which manages input devices, an input job control unit which interprets an input job, an output job control unit which organizes job setting information, an output device management unit which assigns output devices, and a job management unit which transfers instructions from the hot folder server application 4a and job management application 49 to the MFP control unit 130 and controls a print job. The input device management unit includes an input device control unit 142. Input signals to the input device management unit include PDL data and image data from a client PC 31, and JDF data, PPML data, and vPDF data from the hot folder server application 4a, the job management application 49, and a job management unit 140.

The input job control unit includes a protocol interpreting unit 143 and job generation unit 144. The protocol interpreting unit 143 receives a series of operation requests sent from the input device control unit 142 as instruction signals called commands (protocols), and interprets an overview of the operation requests to convert these requests into operation procedures that can be understood inside the MFP. On the other hand, the job generation unit 144 generates an internal job that describes processes to be executed inside the MFP. The generated internal job includes a scenario which defines processes to be applied inside the MFP and destinations, and flows inside the MFP according to the scenario.

The output job control unit includes a job analysis unit 145, binder analysis unit 146, document analysis unit 147, and page analysis unit 148, and generates job setting information and image information. The job analysis unit 145 analyzes details of job setting information 149 associated with a whole job such as a document name to be printed, the number of copies to be printed, designation of a discharge tray as an output destination, and a binder order of a job including a plurality of binders. The binder analysis unit 146 analyzes details of binder setting information 14a associated with a whole binder such as a setting of a bookbinding method, a staple position, and a document order of a binder including a plurality of documents. The document analysis unit 147 analyzes details of document setting information 14b associated with a whole document such as a page order of a document including a plurality of pages, designation of double-sided printing, and addition of a cover and slip sheet. The page analysis unit 148 analyzes details of page setting information 14c associated with various setting pages such as a resolution of an image, and an orientation of an image (landscape/portrait). Also, when PDL data is input, the page analysis unit 148 calls the RIP unit 137 to apply rasterize processing. Note that upon generation of image information, the RIP unit 137 is called to generate page image information 14f by the rasterize processing. The page image information 14f is compressed by the compression/decompression unit 13a, and is then stored in association with setting information in the document management unit 13b.

The output device management unit includes an output device control unit 14d. Image information saved in the document management unit 13b is decompressed by the compression/decompression unit 13a when it is output, and is sent to the output device management unit together with the associated setting information. The output device control unit 14d schedules processes inside the MFP in output devices such as the printer unit 139 and inline finisher 13d.

A communication unit 141 executes communication processing with the hot folder server application 4a and job management application 49, so as to exchange a print status and to receive a print job. The job management unit 140 receives PPML data and JDF data as a print job, and also receives a start, suspension, or cancel instruction of a print job, and a change instruction of the processing contents, from the external hot folder server application 4a and job management application 49 via the communication unit 141. Also, the job management unit 140 sends an instruction to change processes of a print job to the respective control units in the MFP according to such instruction contents. After that, the job management unit 140 sends a status of a print job which is being executed in the MFP to an EFM (Embedded Finishing Manager: not shown), which is arranged in the system to control, for example, finishing processing.

<Re-Print Range Change Processing of Variable Job>

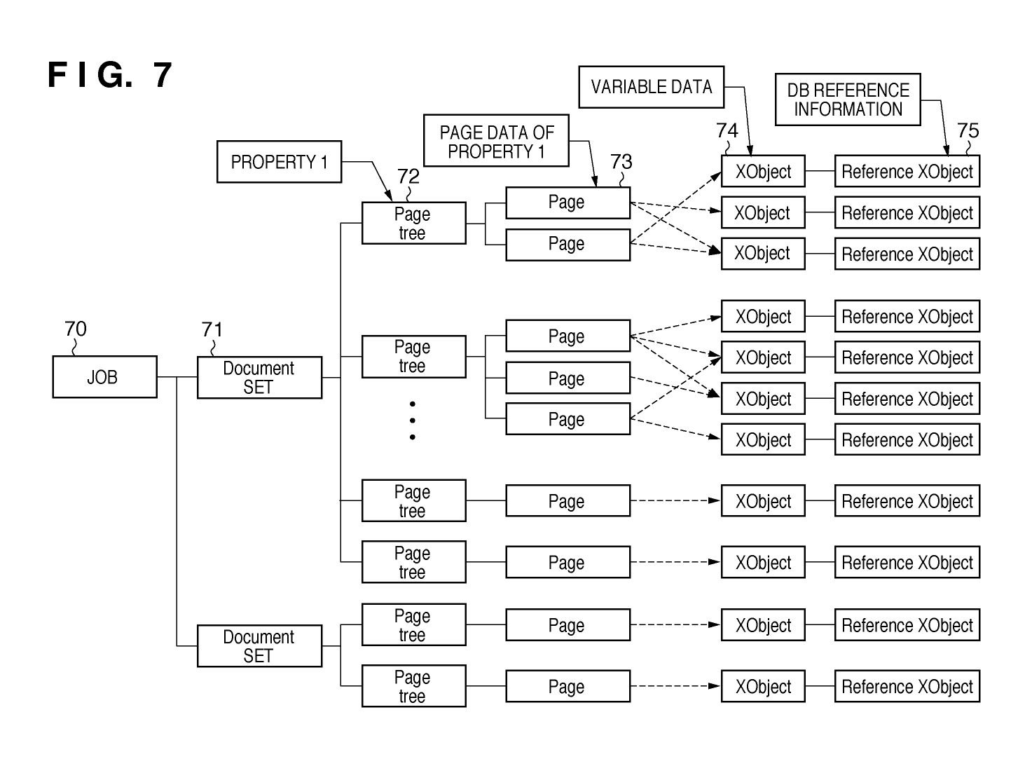

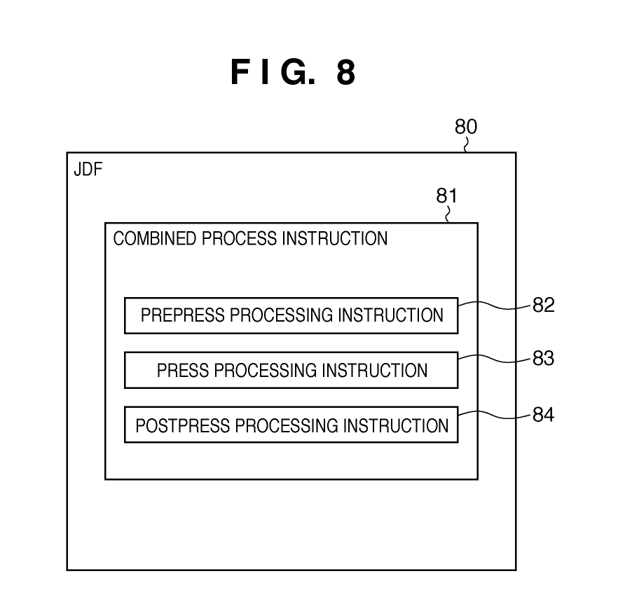

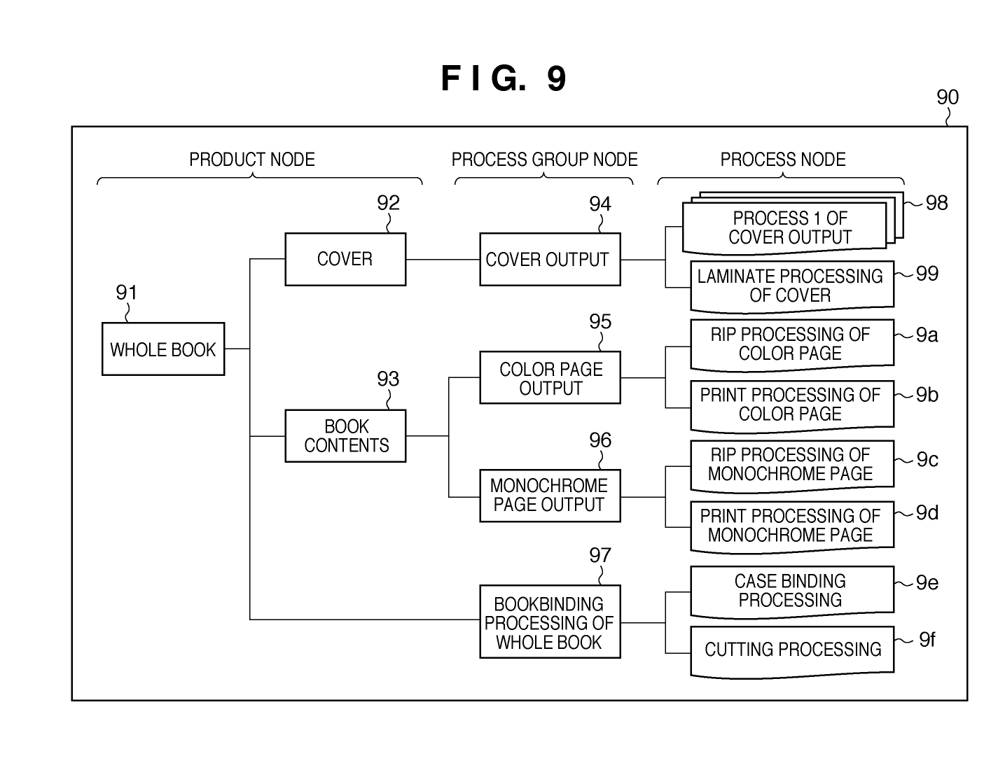

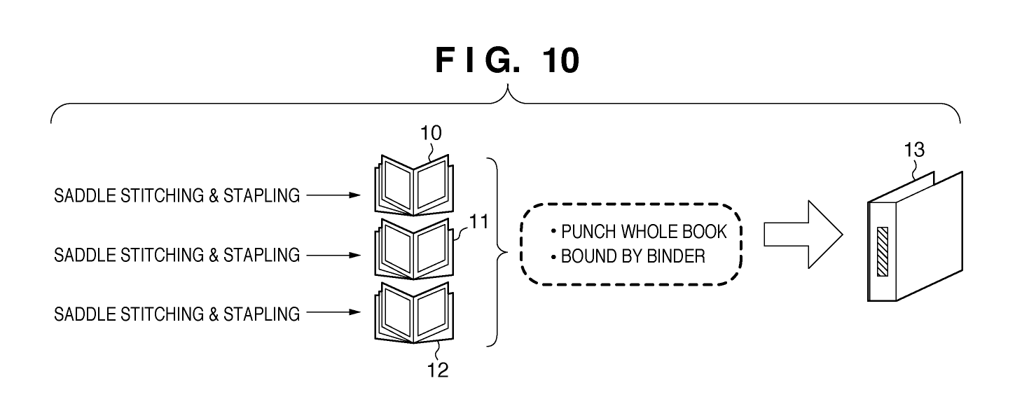

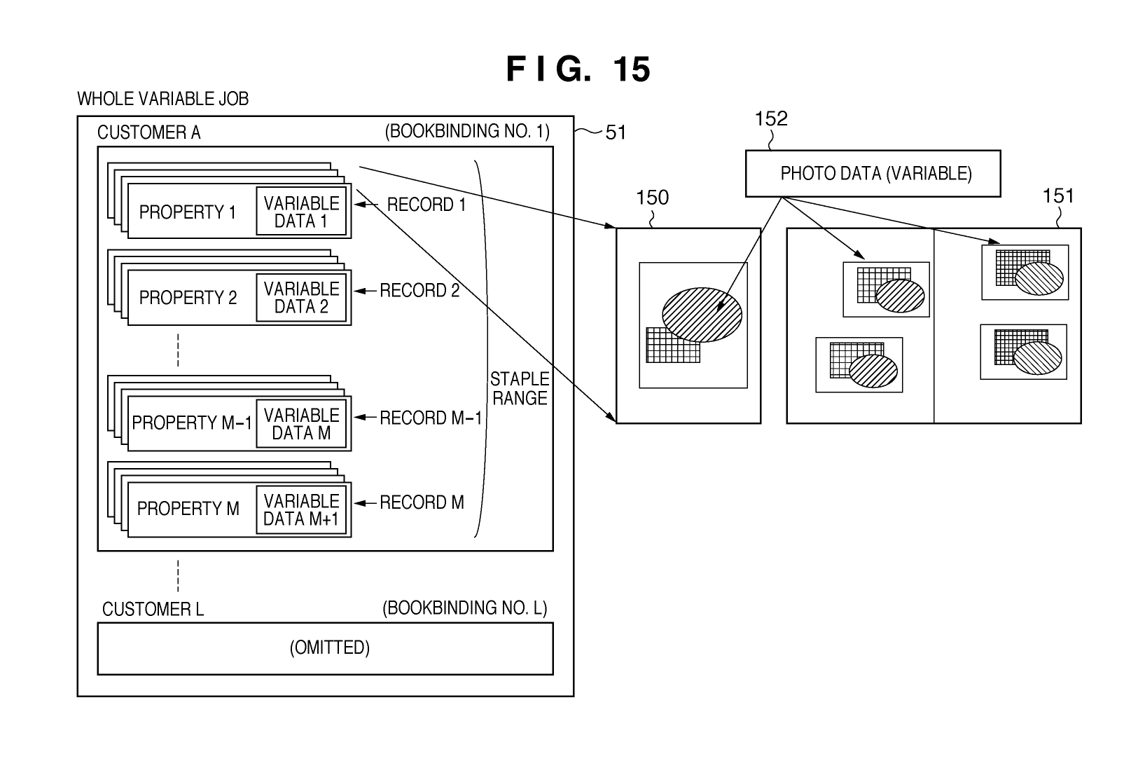

Processing for extending a re-print range up to a finishing range of, for example, a staple setting or case binding setting at the time of re-print processing of a variable job will be described below as the first embodiment with reference to FIGS. 15 to 19. In this embodiment, a record indicates a minimum page group including a plurality of pages in a variable job and, for example, a Page tree 72 in FIG. 7 in the following description.

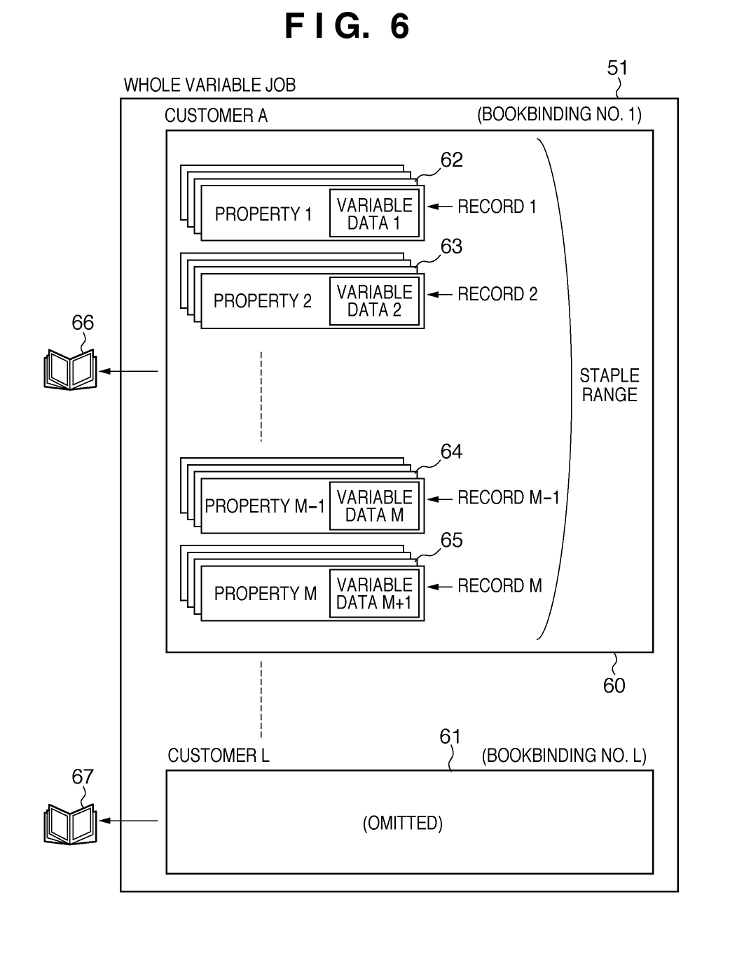

FIG. 15 shows an example of a variable job in this embodiment. This embodiment uses the variable job shown in FIG. 6 as an example. The variable job includes a plurality of records, and those of the plurality of records are designated to form subset staple ranges. In variable data 51, reference numeral 150 denotes a cover as the first page of record 1 (property 1). Reference numeral 151 denotes the second and third pages laid out on pages after the cover is turned. Reference numeral 152 denotes variable data used in record 1. In this embodiment, assume that the variable data 152 include photo data such as JPEG or TIFF data.

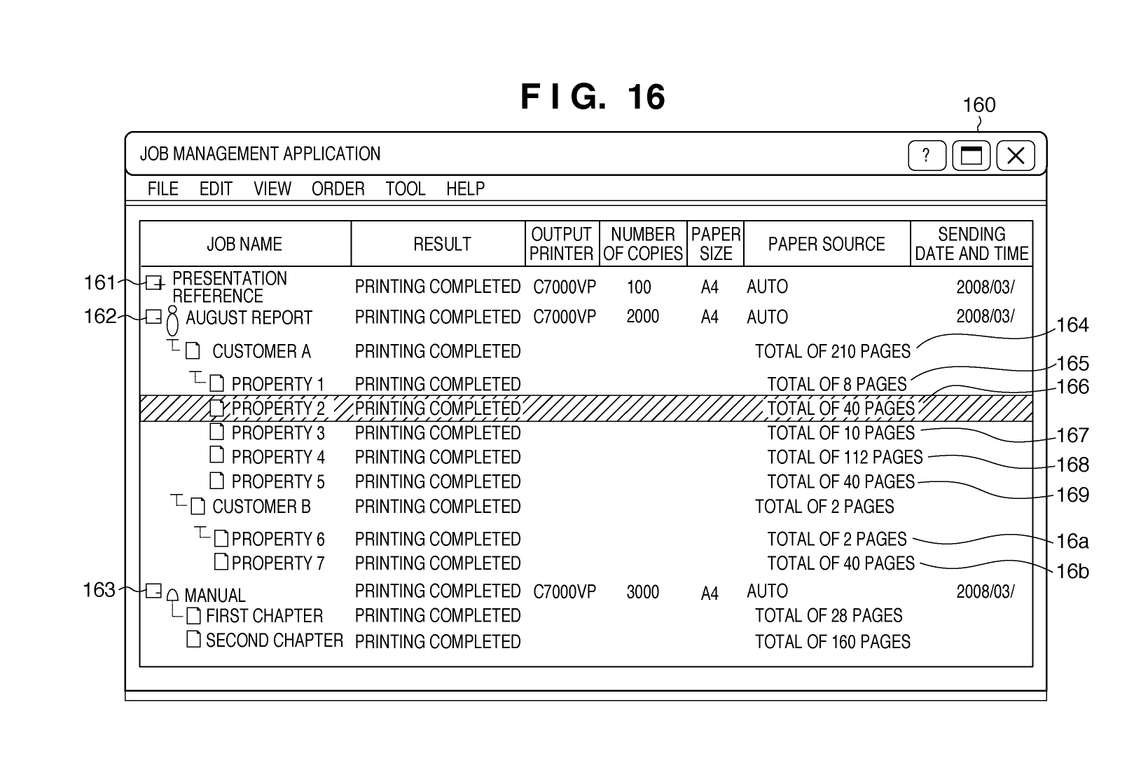

FIG. 16 shows a job history displayed on a dialog of the job management application 49 after the print processing of the variable job shown in FIG. 15 is complete. A job management dialog 160 is displayed by the job management application 49, and hierarchically displays job processing contents. Reference numeral 162 denotes the variable job shown in FIG. 15; and 161 and 163, jobs sent from the hot folder server application 4a. Reference numeral 164 denotes a record group for customer A, which corresponds to a data group 60 in FIG. 6. Reference numeral 165 denotes a record of the variable job, which forms property 1, and corresponds to a data group 62 in FIG. 6. Likewise, reference numerals 166 to 169 denote records for customer A; and 16a and 16b, records for customer B. In this embodiment, a record 166 is designated as a re-print range. The re-print processing is executed for the reason that, for example, variable data that configure property 2 are updated.

As a method of selecting property 2, the user designates it as a target record by a mouse pointer which is operated in synchronism with a pointing device on the job management dialog 160, or selects it by inputting the name of property 2 using a keyboard. This selection is accepted as a re-print target. In this embodiment, the variable job 162 is described as an example that executes print processing for customers A and B. However, the variable job 162 may include data for a larger number of customers, as shown in FIG. 6.

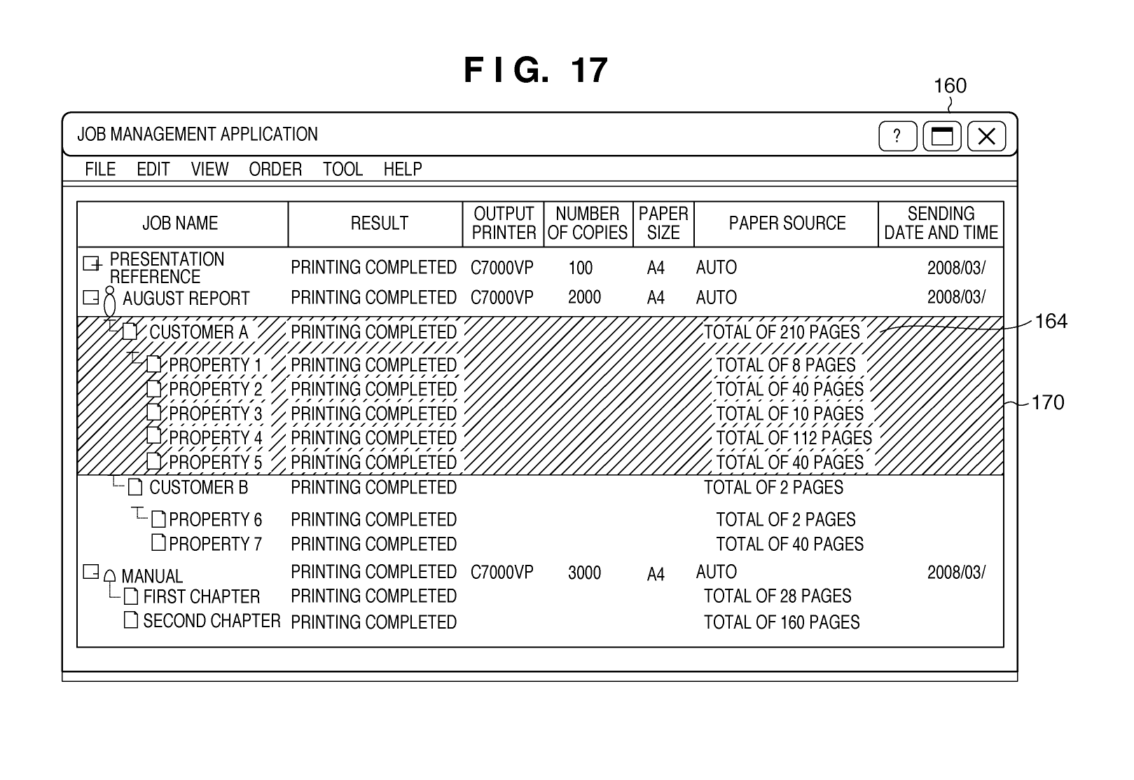

FIG. 17 is a view for explaining the job management dialog 160 displayed when the user issues a print instruction or issues a display instruction of a print range in consideration of a finishing setting on the dialog shown in FIG. 16.

In FIG. 16, only the record 166 is selected as a print range. However, in FIG. 17, a record group 170 as all the records for customer A is selected as a selection range. As described above using FIG. 6, the record 166 is one record included in a staple range. By contrast, since a minimum staple range corresponds to the record group 170, the entire minimum staple range 170 including the record 166 is selected.

Assume that the staple range described using FIG. 6 is described not in variable data but in an independent file as a print instruction in this embodiment. The print instruction is configured by, for example, a JDF file.

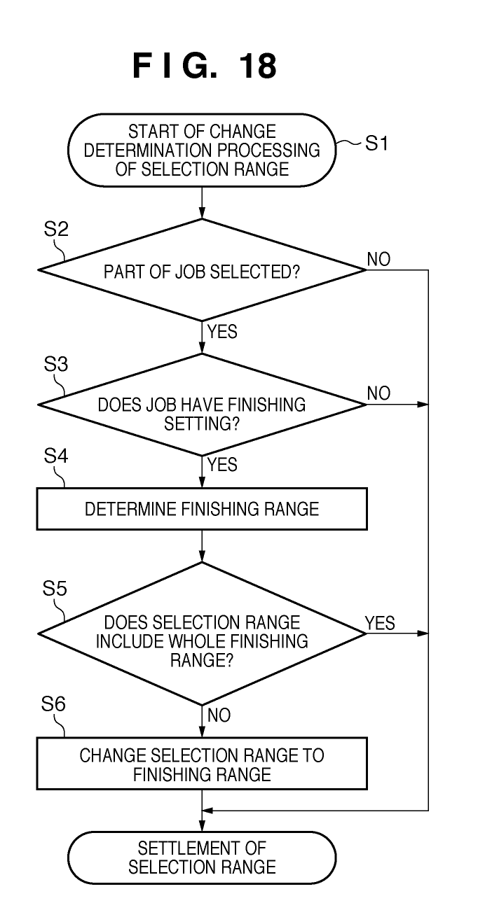

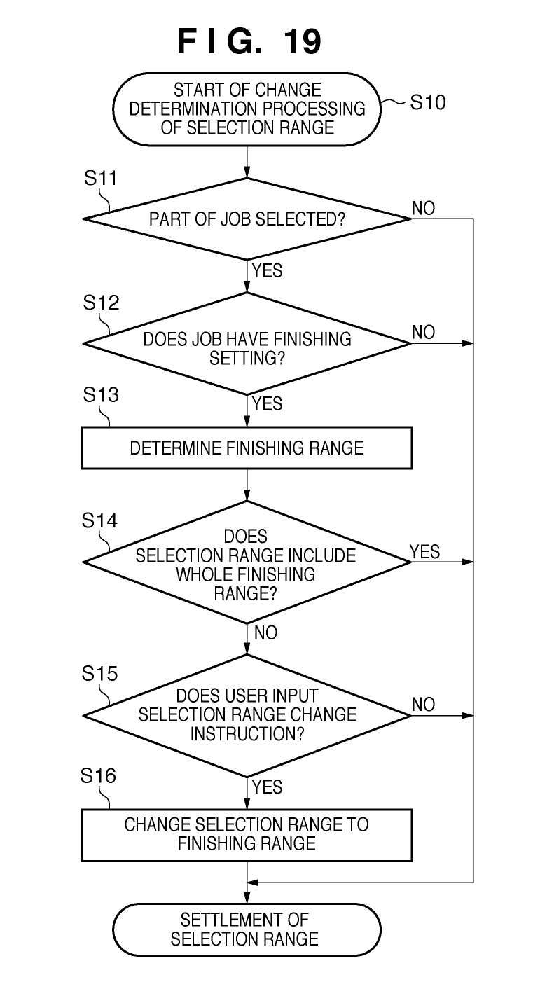

FIGS. 18 and 19 are flowcharts for explaining the first embodiment. A description will be given first with reference to the flowchart shown in FIG. 18.

When the user instructs to change the selection range, as shown in FIG. 17, the processing starts. It is determined in step S2 if a variable job is partially selected as the selection range. If a whole variable job is selected, the processing ends; if a job is partially selected, the process advances to step S3. It is determined in step S3 if the variable job selected to execute re-print processing includes a finishing setting. If the variable job does not include any setting, the processing ends; if the variable job includes a finishing setting, the process advances to step S4. In step S4, subset finishing setting ranges in the whole variable job are confirmed, and the setting ranges are recorded on a memory. Then, the process advances to step S5 to determine if the selected re-print range includes only a part or whole of a finishing designated range. If the selection range includes a whole finishing range of each individual job, the processing ends; otherwise, the process advances to step S6. In step S6, a print range is changed so that the selected re-print range matches a whole finishing range. As a result, the changed print range corresponds to a finishing designated range including the selected print range.

A description will be given below with reference to the flowchart shown in FIG. 19. In the processing of the flowchart shown in FIG. 19, a determination process about a print range change instruction from the user is added as step S15 between steps S5 and S6 in the flowchart shown in FIG. 18. In step S15, a message for confirming with the user as to “whether or not a print range is changed in correspondence with a finishing range” is displayed on the screen. If the user inputs a change instruction, the process advances to step S16 to change the print range; otherwise, the processing ends.

As described above, when print settings of types including a staple setting and case binding setting are made, output products upon execution of re-print processing are handled to have a range, which is suited for a replace operation, and can be easily used by the user.

### Second Embodiment

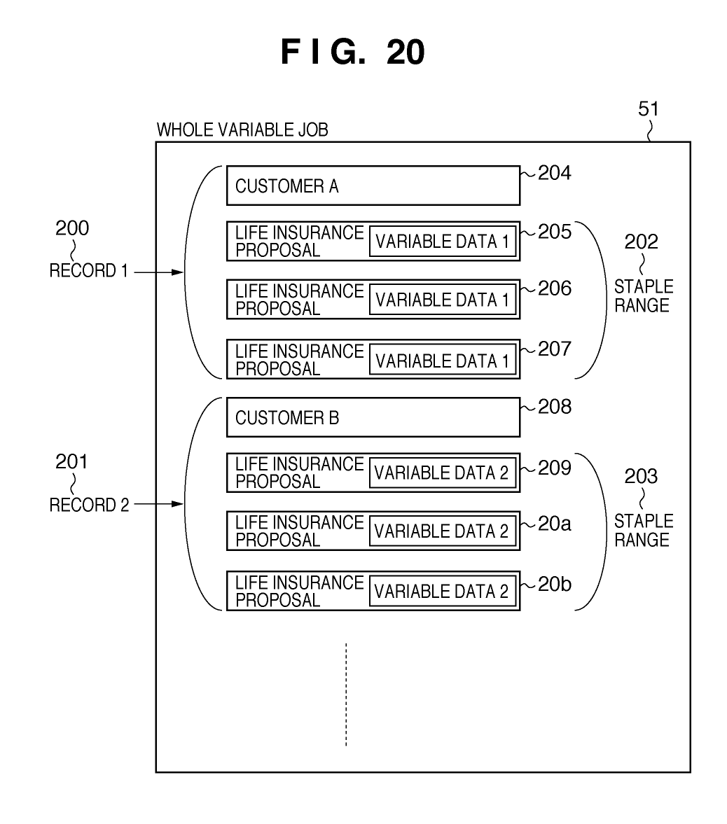

Processing for reducing a re-print range to a finishing range of stapling or case binding upon execution of re-print processing of a variable job will be described below as the second embodiment with reference to FIGS. 20 to 22.

FIG. 20 is a view for explaining the configuration of a variable job according to the second embodiment. Reference numeral 51 denotes a whole variable job; and 200 and 201, records which configure the variable job. In the second embodiment, assume that records of printed products for customer A and those for customer B are independently described. The following description will be given in combination with FIG. 7 which shows the variable job structure. The variable job includes one JOB node 70 and one Document SET node 71, and also a plurality of Page trees 72. Reference numerals 204 to 207 denote page data which configure record 1, which correspond to Page nodes 73 in FIG. 7. Likewise, reference numerals 208 to 20b denote page data which configure record 2. Reference numeral 202 denotes a subset staple range in record 1; and 203, that in record 2. Also, as shown in FIG. 20, variable data are used in pages within these staple ranges.

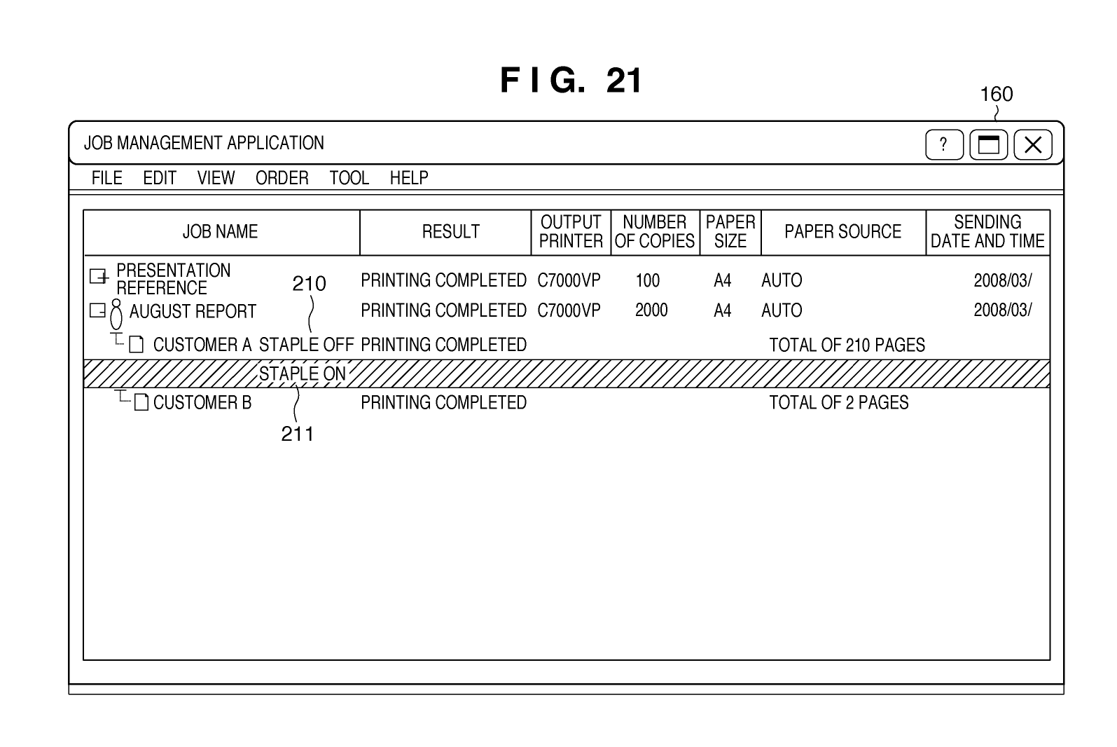

FIG. 21 shows an example in which only a range designated with a finishing setting for customer A is selected upon execution of re-print processing of data for customer A in the variable job in FIG. 20. Reference numeral 210 denotes a position where a finishing setting is OFF in data for customer A, which indicates the page 204 in FIG. 20. Reference numeral 211 denotes a position where a finishing setting is ON, which corresponds to a range from the pages 205 to 207 in FIG. 20.

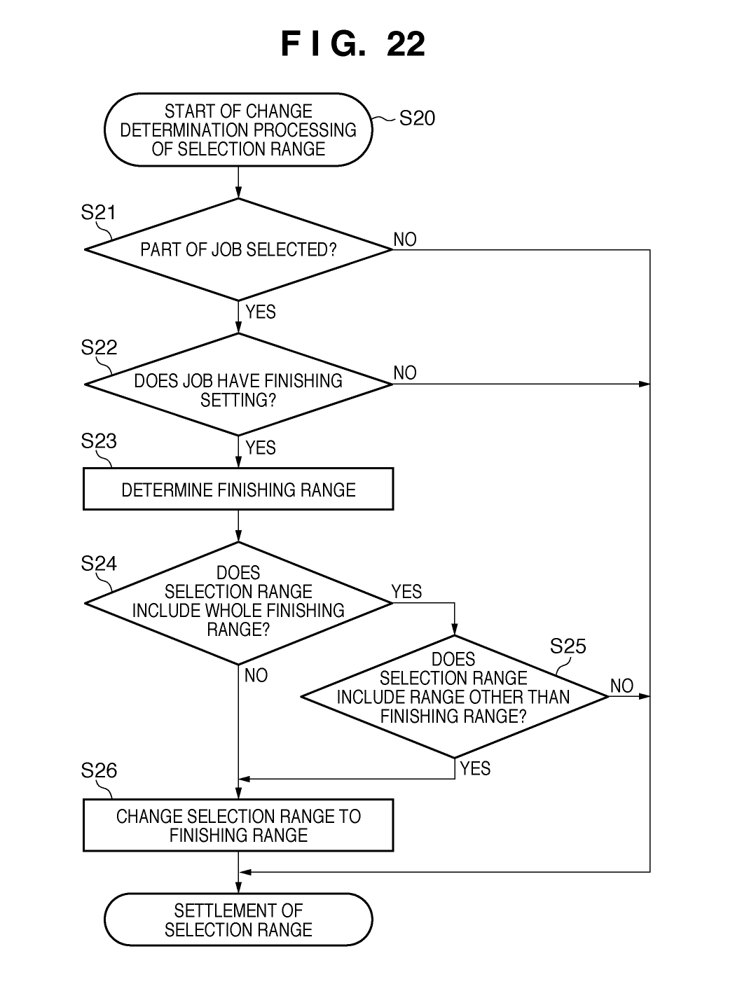

FIG. 22 is a flowchart for explaining the second embodiment. Steps S20 to S24 are equivalent to the corresponding processes in the flowchart shown in FIG. 18 according to the first embodiment. If it is determined in step S24 that a whole finishing range is included, the process advances to step S25. If it is determined in step S25 that a selection range matches the whole finishing setting range, the processing ends. If the selection range does not match the whole finishing setting range, a re-print range includes a range which is not related to the finishing setting, and the process advances to step S26. In step S26, a print range is changed so that the selected re-print range matches a whole finishing range.

As described above, when print settings of types including a staple setting and case binding setting are made, output products having replace positions desired by the user can be easily obtained within a minimum range. The first and second embodiments can be selectively used depending on an object to be printed.

### Third Embodiment

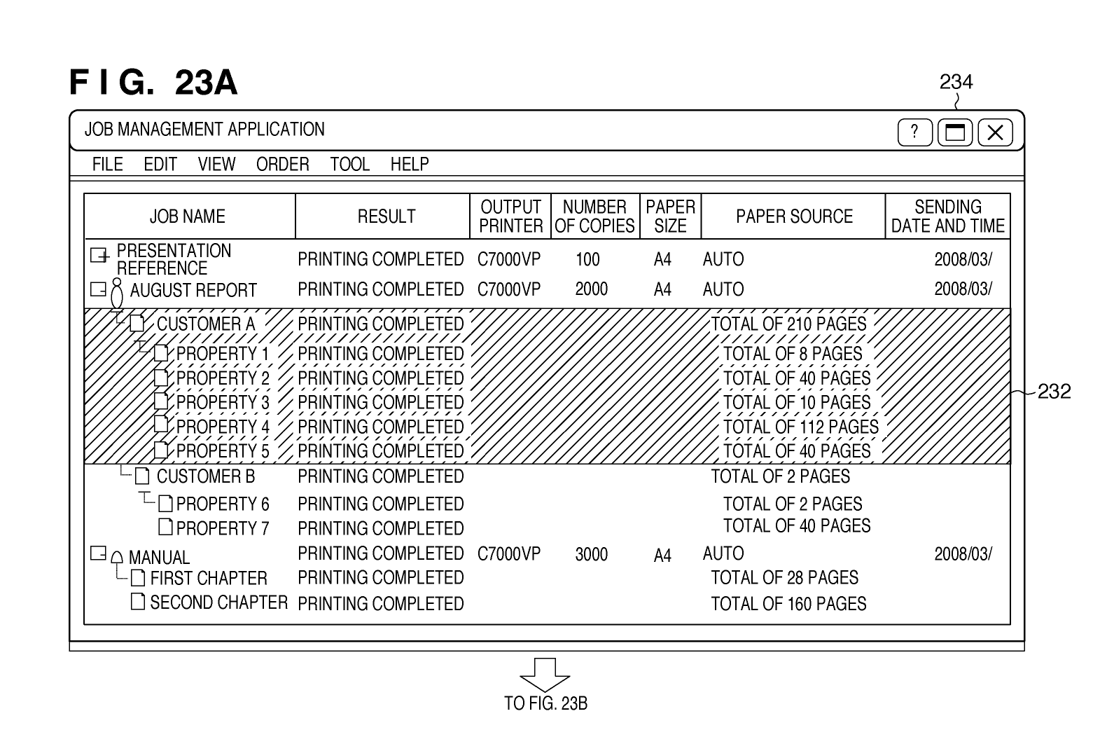

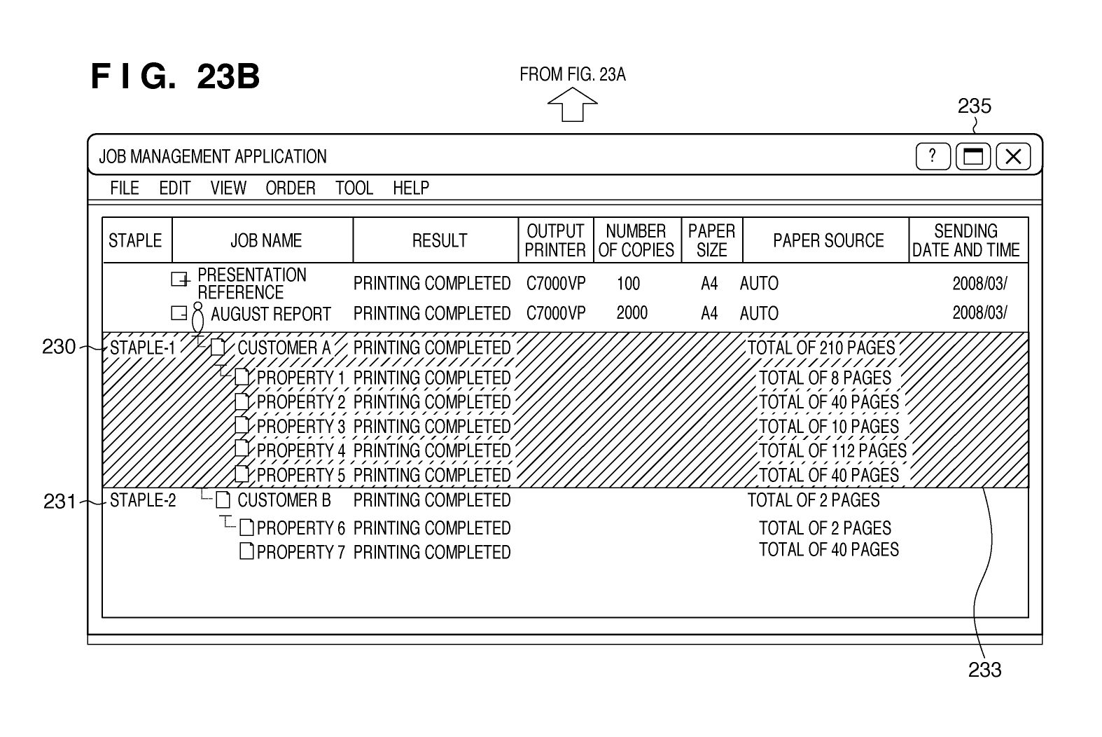

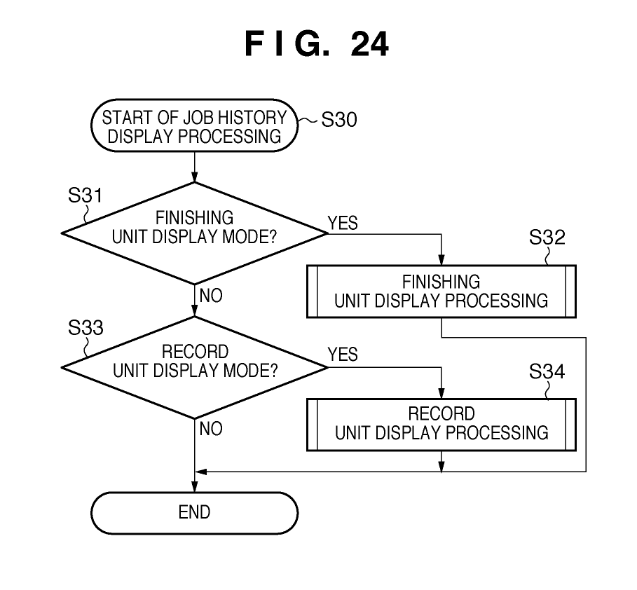

Processing for switching a variable job history display mode between a finishing unit display mode and record unit display mode will be described below as the third embodiment with reference to FIGS. 23A, 23B, and 24. This embodiment can be practiced in combination with the first or second embodiment.

FIGS. 23A and 23B show an example in which a job management dialog 160 is switched between a finishing unit display mode and record unit display mode. Reference numeral 234 denotes a dialog on which the processing contents and designated range are displayed in the record unit display mode; and 235, an example of a dialog on which the processing contents and designated range are displayed in the finishing unit display mode. The job management dialog 234 displays variable jobs in the record unit display mode, and a range 232 selects all records which configure printed products for customer A. The job management dialog 235 also includes a field for displaying staple information, and reference numerals 230 and 231 denote staple settings selected as finishing settings. Reference numeral 233 denotes a highlight indicating that “staple 1” is selected, and a job is selected for each staple setting on the job management dialog 235. That is, the user cannot select only property 1, and when he or she selects a range of property 1 using a mouse pointer, it is handled that the user selects the range 233.

FIG. 24 is a flowchart for explaining the third embodiment. When job history display processing on the job management dialog is started in response to a user instruction, it is determined in step S31 if the user designates the finishing unit display mode. If the user designates the finishing unit display mode, the process advances to step S32 to display a dialog similar to the dialog 235 in FIG. 23B. If the user does not designate the finishing unit display mode, the process advances to step S33 to determine if the user designates the record unit display mode. If the user designates the record unit display mode, the process advances to step S34 to display a dialog similar to the dialog 234 in FIG. 23A. If there is no display mode other than the finishing unit display mode and record unit display mode, step S33 may be omitted to directly execute the record unit display mode.

As described above, since a print range can be displayed in a mode that can be easily used by the user in the re-print operation by the user, user's convenience can be improved.

### Fourth Embodiment

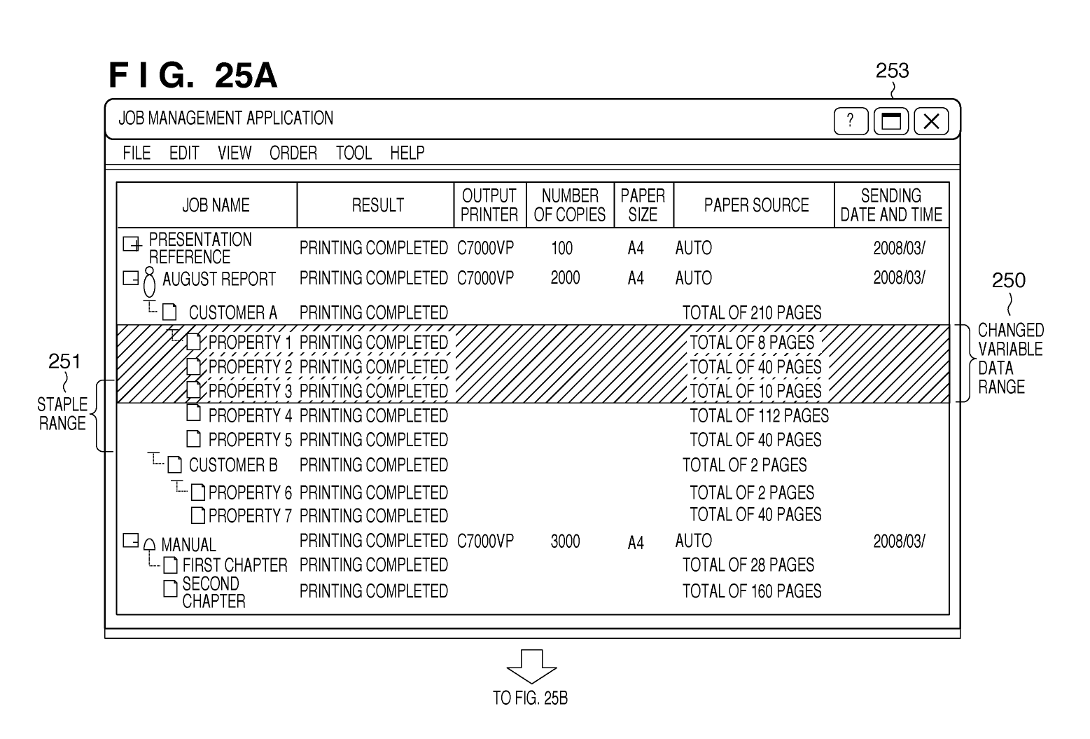

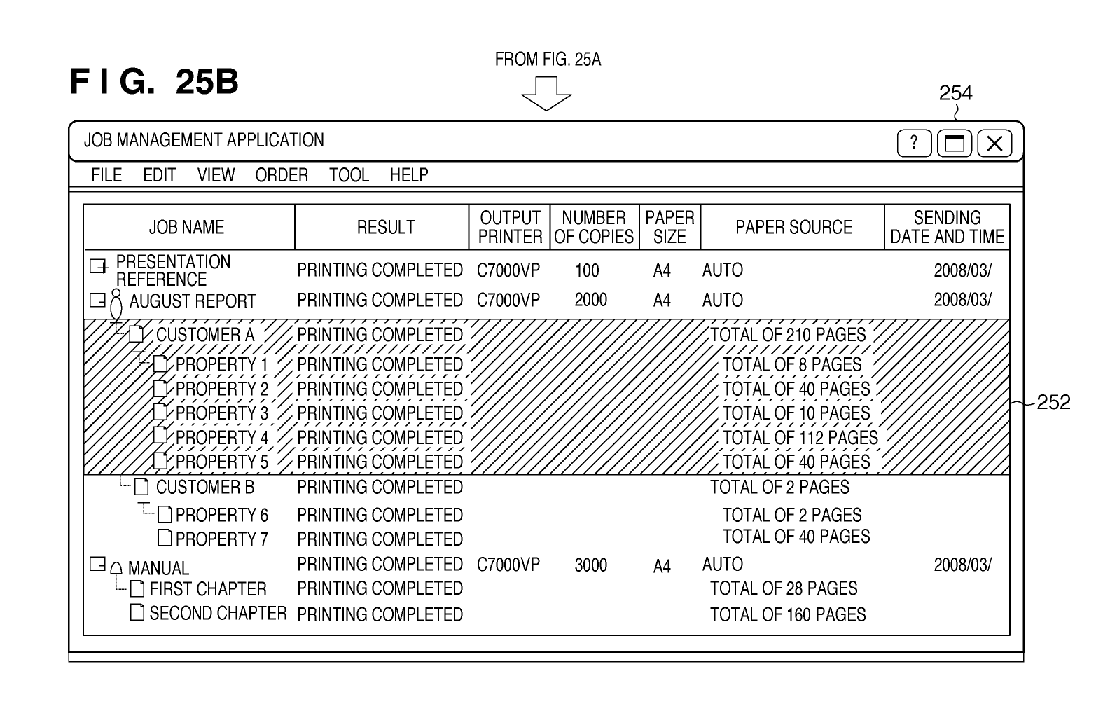

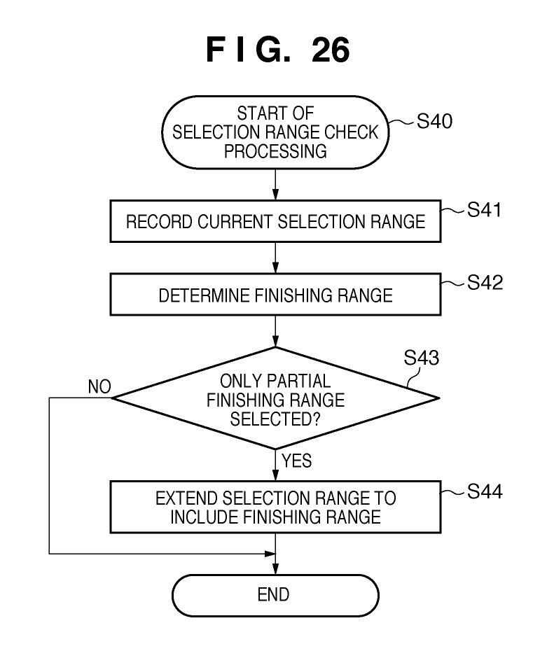

Processing for changing a print range to optimal one in consideration of a finishing setting and its range when records using changed variable data are selected as a re-print range will be described below as the fourth embodiment with reference to FIGS. 25A, 25B, and 26. FIGS. 25A and 25B are views showing a job management display dialog to explain the fourth embodiment. A job management dialog 253 shows a state in which records which use changed variable data are selected as target records. Reference numeral 250 denotes a record range in which changed variable data are used; and 251, a staple setting range in a job for customer A. A job management dialog 254 shows a state in which a whole staple range 251 is re-set as a print range so as not to issue a print instruction of only a part of the finishing range from the job management window 253, and shows a designated range 252 changed from the range 250.

FIG. 26 is a flowchart for explaining the fourth embodiment. When selection range check processing is started, the current selection range is recorded on a memory in step S41. In step S42, a finishing setting set for the whole selected variable job is recorded on a memory. It is determined in step S43 if only a part of the finishing range is included in a re-print range. If the whole finishing range is included, the processing ends; if only a part of the finishing range is included, the process advances to step S44. In step S44, the selection range is extended to include each individual full subset finishing setting range as a minimum unit using the selection range information recorded on the memory and subset finishing setting information. In this manner, the display result of the job management dialog 254 shown in FIGS. 25A and 25B are obtained.

As described above, output products upon execution of re-print processing are handled to have a range suited for a replace operation, thus facilitating use by the user.

### Fifth Embodiment

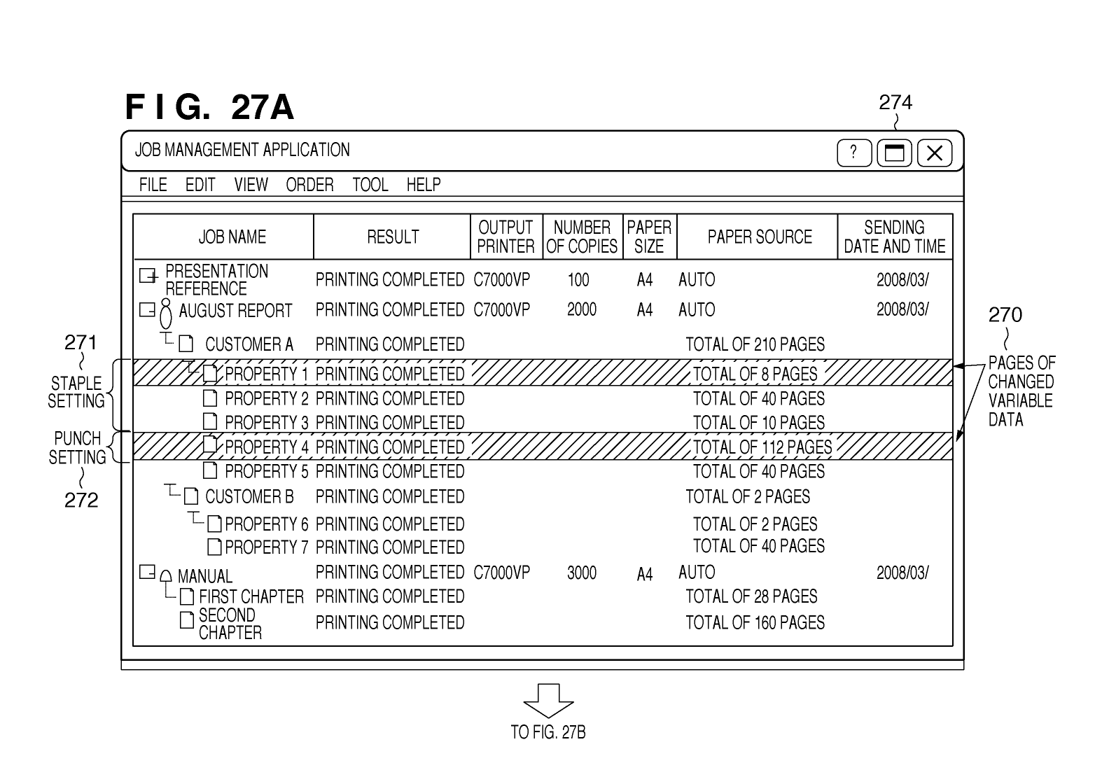

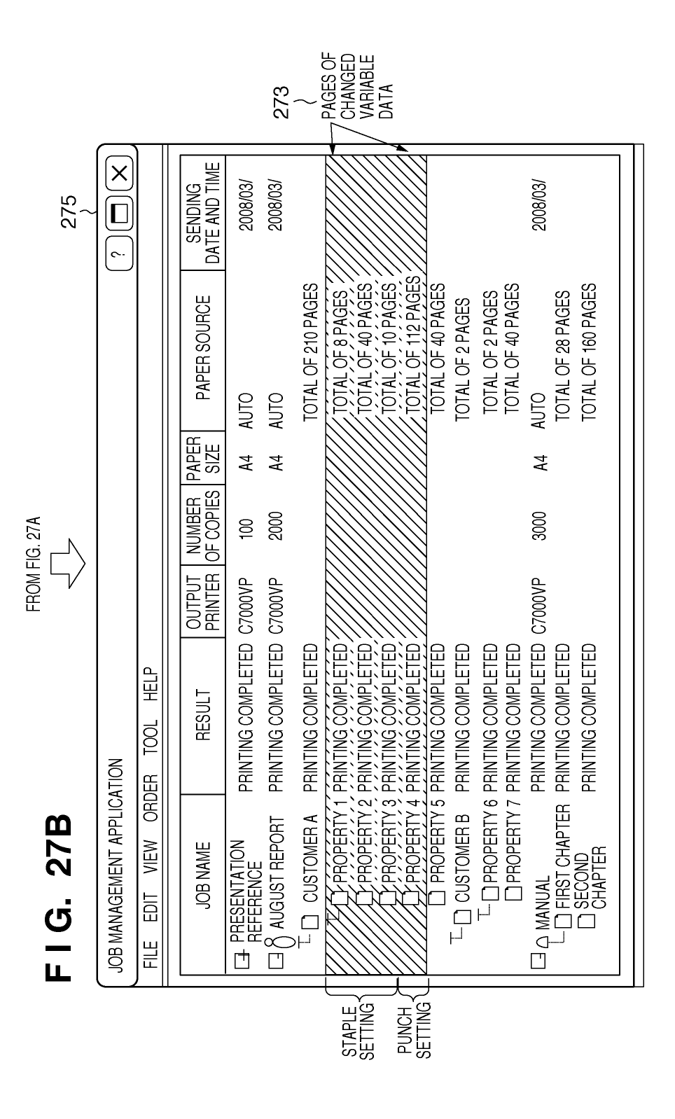

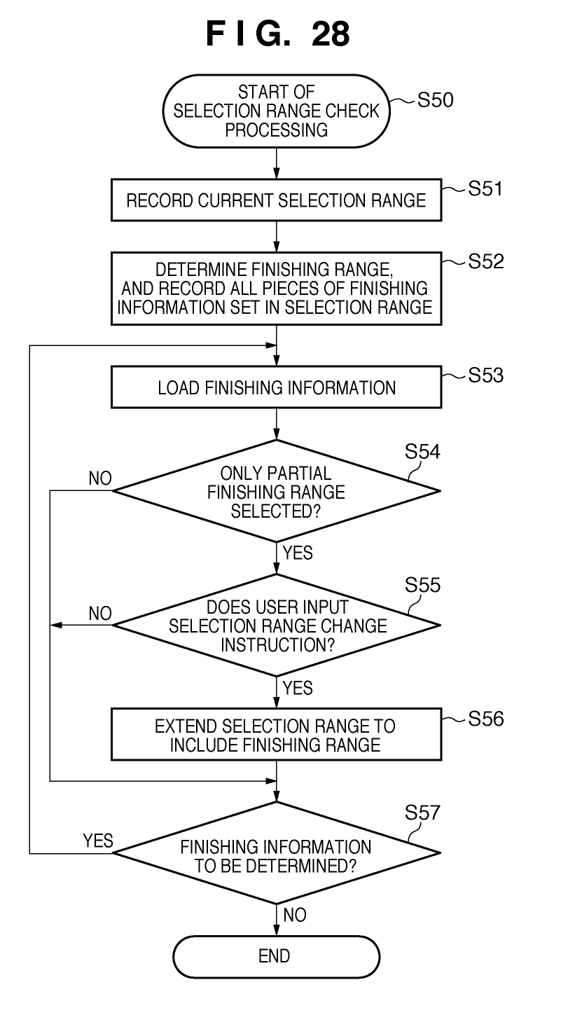

Processing for changing a print range to optimal one in consideration of a setting range of a special finishing setting such as a punch setting when such special finishing setting is made in the aforementioned embodiment will be described below as the fifth embodiment with reference to FIGS. 27A, 27B, and 28. Assume that the staple setting and case binding setting as the targets of the first embodiment are defined as the first finishing settings, and a punch setting as the target of the fifth embodiment is defined as the second finishing setting.

FIGS. 27A and 27B are views showing a job management display dialog used to explain the fifth embodiment. A job management dialog 274 shows a state in which only records using changed variable data are selected as re-print targets. In this embodiment, two records “property 1” and “property 4” for customer A of a variable job “August report” are selected. Reference numeral 270 denotes selected target records, that is, records using changed variable data. Reference numeral 271 denotes a staple setting range in a job for customer A. In this embodiment, the staple setting range includes properties 1 to 3. Likewise, reference numeral 272 denotes a punch setting range, which includes properties 4 and 5. As shown in a job management dialog 275, the designated range is changed to allow the user to replace output products in consideration of finishing setting information. Reference numeral 273 denotes a changed re-print range.

FIG. 28 is a flowchart for explaining the fifth embodiment. Steps S50 and S51 are the same as in the flowchart shown in FIG. 26. In step S52, in this embodiment, only all finishing settings designated for the currently selected target records are temporarily recorded on a memory in place of the finishing settings of a whole variable job. More specifically, such finishing settings correspond to staple setting information 271 and punch setting information 272 in FIG. 27A. In step S53, one finishing information is loaded from the plurality of pieces of finishing information recorded on the memory. For example, the staple setting information 271 in FIG. 27A is loaded. The process then advances to step S54 to determine if only a partial range in the loaded finishing information is selected. If a whole range is selected, the process jumps to step S57; if only a partial range is selected, the process advances to step S55. In case of the staple setting information 271 in FIG. 27A, since only a partial staple range is selected, the process advances to step S55. In step S55, the control inquires the user as to whether or not to change the selection range. If the user inputs a change instruction, the process advances to step S56; otherwise, the process jumps to step S57. In step S56, a print range is changed to include the finishing range. When the user inputs a change instruction of the selection range in association with the staple setting information 271 in FIG. 27A, the print range is changed to the range 273. The process then advances to step S57 to judge if finishing settings to be determined still remain. If finishing settings to be determined still remain, the process returns to step S53 to continue the processing. If no finishing setting to be determined remains, the processing ends. In case of the example shown in FIGS. 27A and 27B, the punch setting information 272 is not determined yet. Hence, the process returns to step S53. In step S53, the punch setting information 272 is loaded. Since it is determined in step S54 that only a partial punch setting range is selected as a re-print range, the process advances to step S55. In step S55, the user need not reflect the punch setting to facilitate replacement, and instructs not to change the designated range. Hence, the process jumps to step S57. Since the determination processing of all the finishing settings is complete, the designated range check processing ends. The job management dialog 275 in FIG. 27B is displayed after the aforementioned processing.

As described above, since the user can adjust a setting range according to his or her intention, output products upon execution of re-print processing are handled to have a range suited to a replace operation, thus improving the user's convenience. In this embodiment, the punch setting has been exemplified. In addition, a second finishing setting includes a cutting setting and folding setting for print products, and the aforementioned processing can be similarly applied to these settings, thus allowing appropriate processing.

### Sixth Embodiment

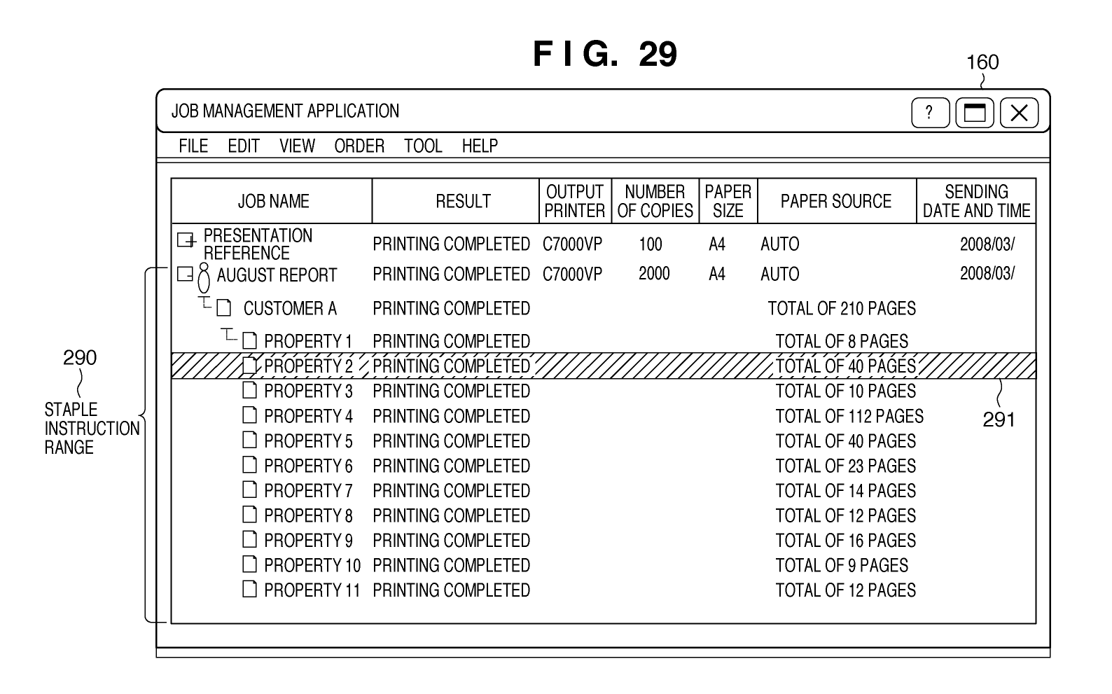

A case will be described below as the sixth embodiment wherein the device side decides subset staple ranges of to a print job depending on its staple capability in place of a user's print instruction setting. Note that the staple capability indicates, for example, the thickness of a booklet that can be stapled at once. Processing for changing a print range to that optimal to a replace operation upon execution of re-print processing will be described below with reference to FIGS. 29 to 31.

FIG. 29 is a view showing a job management dialog used to explain the sixth embodiment. A job management dialog 160 displays a job history. Reference numeral 290 denotes a staple range designated by the user as a print setting. Also, reference numeral 291 denotes a selected record to be re-printed by changing variable data.

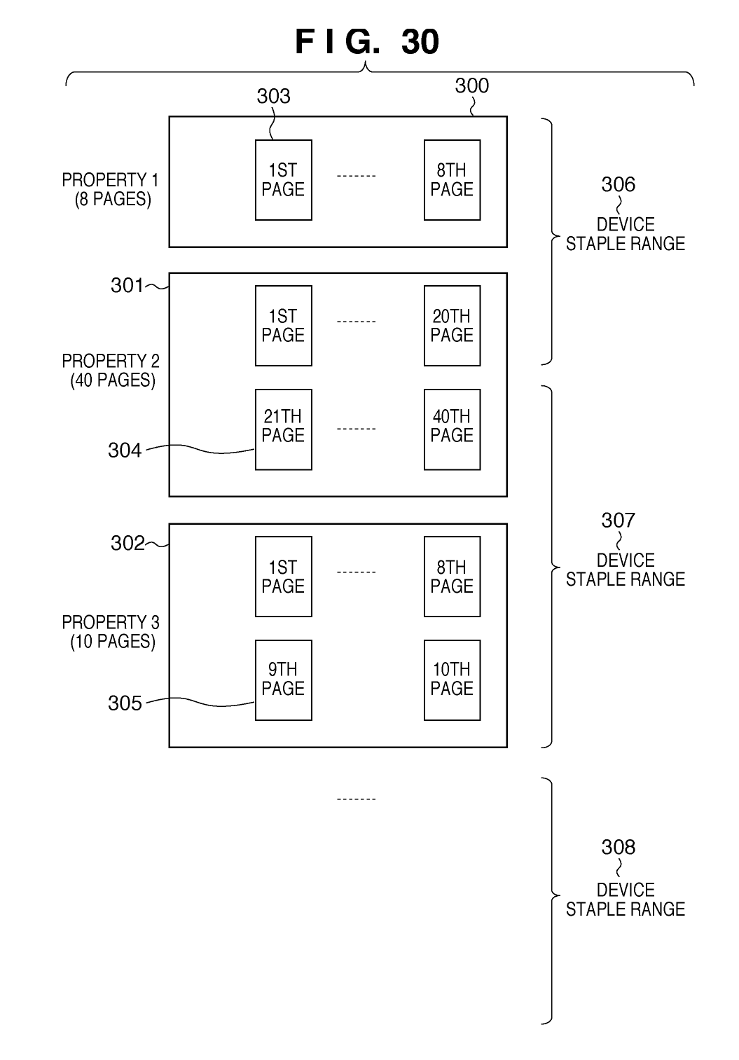

FIG. 30 is a view for explaining actual device subset staple ranges in a variable job “August report” in FIG. 29. Reference numeral 300 denotes a page group of record 1; 301, that of property 2; and 302, that of property 3. Reference numerals 303, 304, and 305 denote pages which configure individual records. Reference numeral 306, 307, and 308 denote stapled ranges which are divided for each paper thickness that can be stapled by the device. In this embodiment, as indicated by the setting 290 in FIG. 29, the user makes the staple setting for all records of the variable job “August report”, but the subset staple output ranges are set depending on the device staple function, as shown in FIG. 30.

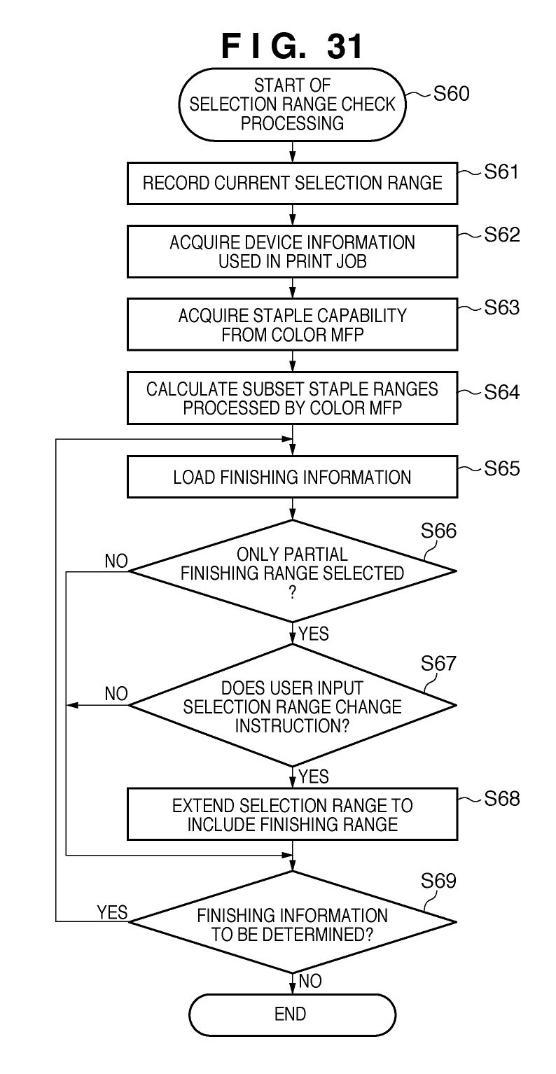

FIG. 31 is a flowchart for explaining the sixth embodiment. When range selection check processing is started in response to a user's instruction, a current re-print designated range is recorded in a memory in step S61. In this embodiment, assume that property 2 in FIG. 29 is recorded as the re-print range. In step S62, device information used in the selected variable job is acquired from a job ticket 53, and is recorded in the memory. The process then advances to step S63 to specify a processing device based on the information acquired in step S62 and to acquire staple capability information that records, for example, paper thickness information that allows stapling by a specified color MFP 37. In step S64, how to decide subset staple output ranges on the device side in the selected variable job “August report” is calculated and is recorded on the memory. The processes in subsequent steps S65 to S69 are the same as those in steps S53 to S57 in the flowchart shown in FIG. 28. In the example of FIG. 30, property 2 is selected. However, when properties 1, 2, and 3 are selected again as a re-print range in consideration of subset staple processing on the device side, the user can execute replace processing more easily.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-049714, filed Mar. 3, 2009, which is hereby incorporated by reference herein in its entirety.

What is claimed is:

1. A management apparatus for managing a job to be processed by a peripheral device having a finishing function, comprising:
a selection unit which accepts a user's selection of a record to be printed upon processing the job including a plurality of records;
a determination unit which determines a finishing setting set in the job;
a decision unit which decides, as print targets, a plurality of records, which include the record to be printed selected by the user's selection accepted by said selection unit and which have the finishing setting determined by said determination unit; and
a generation unit which generates print instruction information based on the plurality of records to be printed, which are decided by said decision unit.

2. The apparatus according to claim 1, wherein said determination unit determines the finishing setting set in the job,
said decision unit decides, when at least one record of a plurality of records having a first finishing setting is the record selected by the user's selection accepted by said selection unit based on a determination result of said determination unit, the plurality of records having the first finishing setting as print targets, and
said decision unit decides, when at least one record of a plurality of records having a second finishing setting is the record selected by the user's selection accepted by said selection unit based on a determination result of said determination unit, the record selected by the user as a print target in place of the plurality of record having the second finishing setting.

3. The apparatus according to claim 2, wherein the first finishing setting includes at least one of a staple setting and a case binding setting.

4. The apparatus according to claim 2, wherein the second finishing setting includes at least one of a punch setting, a cutting setting, and a folding setting.

5. The apparatus according to claim 1, further comprising a confirmation unit which confirms with the user about the plurality of records to be printed decided by said decision unit,
wherein said generation unit generates the print instruction information based on the plurality of records in accordance with an instruction indicating that the user permits to select the plurality of records decided by said decision unit as print targets via said confirmation unit.

6. The apparatus according to claim 1, wherein when a plurality of records which are selected as print targets by the user's selection accepted by said selection unit include a record having no finishing setting, said decision unit decides the plurality of selected records as print targets except for the record having no finishing setting.

7. The apparatus according to claim 1, further comprising a control unit which controls a screen to output a plurality of records included in the job and the records decided as print targets by said decision unit in a display mode that allows the user to identify the records.

8. The apparatus according to claim 7, wherein said control unit controls the screen to output a plurality of records having the finishing setting set in the job in a display mode that allows the user to identify that the records have the finishing setting.

9. A management method in a management apparatus for managing a job to be processed by a peripheral device having a finishing function, comprising:
a selection step of accepting a user's selection of a record to be printed upon processing the job including a plurality of records;
a determination step of determining a finishing setting set in the job;
a decision step of deciding, as print targets, a plurality of records, which include the record to be printed selected by the user's selection accepted in the selection step and which have the finishing setting determined in the determination step; and
a generation step of generating print instruction information based on the plurality of records to be printed, which are decided in the decision step.

10. A computer-readable storage medium storing a program for making a computer function as:
a selection unit which accepts a user's selection of a record to be printed upon processing a job including a plurality of records;
a determination unit which determines a finishing setting set in the job;
a decision unit which decides, as print targets, a plurality of records, which include the record to be printed selected by the user's selection accepted by said selection unit and which have the finishing setting determined by said determination unit; and
a generation unit which generates print instruction information based on the plurality of records to be printed, which are decided by said decision unit.

11. A print system for managing a job to be processed by a peripheral device having a finishing function, comprising:
a selection unit which accepts a user's selection of a record to be printed upon processing the job including a plurality of records;
a determination unit which determines a finishing setting set in the job;
a decision unit which decides, as print targets, a plurality of records, which include the record to be printed selected by the user's selection accepted by said selection unit and which have the finishing setting determined by said determination unit; and
a processing unit which executes print processing and finishing processing of the plurality of records decided as the print targets by said decision unit.
